(19) United States
(12) Patent Application Publication
(10) Pub. No.: US 2013/0278738 A1
(43) Pub. Date: Oct. 24, 2013

(54) IMAGE PROCESSING APPARATUS AND IMAGE PROCESSING METHOD

(71) Applicant: SONY CORPORATION, Tokyo (JP)

(72) Inventor: Tsuneo Hayashi, Chiba (JP)

(73) Assignee: Sony Corporation, Tokyo (JP)

(21) Appl. No.: 13/860,585

(22) Filed: Apr. 11, 2013

(30) Foreign Application Priority Data
Apr. 18, 2012 (JP) 2012-094660

(51) Int. Cl. H04N 5/235

(52) U.S. Cl. CPC H04N 5/2354
USPC 348/68

(57) ABSTRACT

An image processing apparatus includes an image separation unit, a correction illumination calculation unit, and an output controller. The image separation unit is configured to separate, from a captured image, an image captured in illumination of a measurement light mode in which an illumination intensity distribution is set to a predetermined spatial distribution. The correction illumination calculation unit is configured to calculate an illumination intensity distribution in a correction light mode in which illumination corresponding to an object is provided, based on the image separated in the image separation unit. The output controller is configured to perform output control of illumination light based on the illumination intensity distribution calculated in the correction illumination calculation unit.

### BACKGROUND

The present disclosure relates to an image processing apparatus and an image processing method, by which light distribution control with a high spatial resolution corresponding to an object is performed for illumination light at the time of imaging.

From the past, imaging apparatuses, for example, endoscope apparatuses have been widely used in order to observe the interior of a pipe or a body cavity. As the endoscope apparatuses, flexible endoscope apparatuses and rigid endoscope apparatuses are used. The flexible endoscope apparatus includes a flexible insertion unit, which is inserted into a curved pipe or a body cavity to observe the interior thereof. The rigid endoscope apparatus includes a rigid insertion unit, which is inserted linearly into a curved pipe or a body cavity toward a target portion to observe the interior thereof.

Examples of the flexible endoscope apparatuses include an optical endoscope apparatus and an electronic endoscope apparatus. The optical endoscope apparatus transmits an optical image captured in a lens system at a leading end thereof to an eyepiece through an optical fiber. The electronic endoscope apparatus includes a lens system and an imaging device at a leading end thereof and converts an image captured in the lens system into an electrical signal in the imaging device to transmit the electrical signal to an external monitor. The rigid endoscope apparatus transmits an optical image to an eyepiece through a relay optical system constituted by connecting lens systems from the leading end thereof. As in the case of the flexible endoscope apparatuses, examples of the rigid endoscope apparatuses also include an electronic endoscope apparatus that converts an image captured in a lens system into an electrical signal in an imaging device to transmit the electrical signal to an external monitor.

In order to obtain an image whose peripheral part and center part are easily viewable in such an endoscope apparatus, for example, Japanese Patent Application Laid-open No. HEI 05-130973 discloses the following technique. Illumination light from a xenon lamp is focused on an incident end of a light guide by a light-focusing lens. Further, an aperture is provided between the incident end of the light guide and the light-focusing lens so that the amount of incoming illumination light is controlled. In addition, by the movement of the light-focusing lens along an optical axis, the distribution of illumination light supplied into a body cavity or the like is controlled. Simultaneously, the aperture is controlled to provide a constant amount of light.

### SUMMARY

Incidentally, in the case where the distribution of illumination light is controlled by the movement of the light-focusing lens along the optical axis, light distribution control with a high spatial resolution is difficult to be performed. For example, in Japanese Patent Application Laid-open No. HEI 05-130973, when illumination light is input to be focused on the incident end of the light guide, a large amount of illumination light is input to a center part of the light guide. Thus, the characteristics of light distribution strongly appear at the center part. Further, when illumination light is input to be focused on a point at the back of the incident end of the light guide, the illumination light is uniformly input. Thus, the characteristics of light distribution become uniform over the peripheral and center parts. However, it is difficult to adjust the illumination intensity of only a certain portion of the center or peripheral part.

In this regard, it is desirable to provide an image processing apparatus and an image processing method that are capable of performing light distribution control with a high spatial resolution corresponding to an object, for illumination light at the time of imaging.

According to a first embodiment of the present disclosure, there is provided an image processing apparatus including: an image separation unit configured to separate, from a captured image, an image captured in illumination of a measurement light mode in which an illumination intensity distribution is set to a predetermined spatial distribution; a correction illumination calculation unit configured to calculate an illumination intensity distribution in a correction light mode in which illumination corresponding to an object is provided, based on the image separated in the image separation unit; and an output controller configured to perform output control of illumination light based on the illumination intensity distribution calculated in the correction illumination calculation unit.

In the embodiment of the present disclosure, the image separation unit separates, from a captured image generated in an imaging unit, an image captured in illumination of a measurement light mode in which an illumination intensity distribution is set to a predetermined spatial distribution, for example, a spatial distribution having a uniform illumination intensity. In the separation of the image, in the case where a captured image is generated in units of screen, for example, in units of frames, a frame image captured in illumination of the measurement light mode is separated from the captured images in units of frames. Resolution conversion processing is performed on the separated image in accordance with a spatial resolution of illumination light, and an illumination intensity distribution in the correction light mode in which illumination corresponding to an object is provided is calculated by the correction illumination calculation unit based on the image obtained after the resolution conversion processing. In the calculation of the illumination intensity distribution, color separation processing is performed on the separated image and thus the illumination intensity distribution in the correction light mode may be calculated based on the image of each color component. The output controller calculation unit performs output control of illumination light based on the calculated illumination intensity.

Further, the image separation unit performs interpolation to generate, based on an image captured in illumination of the correction light mode, an image that is captured in illumination of the correction light mode and corresponds to a period of the image captured in illumination of the measurement light mode. For example, the image separation unit generates, by interpolation based on a frame image captured in illumination of the correction light mode, a frame image that is captured in illumination of the correction light mode and corresponds to a period of the image captured in illumination of the measurement light mode. An operation controller operates the imaging unit, the image separation unit, the correction illumination calculation unit, and the output controller in synchronization with one another. Further, an optical path controller allows an optical path guiding light from an object to the imaging unit to be used as an optical path of the illumination light.

An illumination unit configured to output the illumination light performs spatial light modulation of the illumination light output from a light source based on a control signal from the output controller, and sets an illumination intensity distribution of the illumination light output in the correction light mode to be a distribution calculated in the correction illumination calculation unit. Further, the illumination unit may drive a light-emitting device based on a control signal from the output controller, and set an illumination intensity distribution of the illumination light output in the correction light mode to be a distribution calculated in the correction illumination calculation unit.

The illumination intensity distribution may be calculated based on a distance to the object measured in a distance measurement unit, a distance to the object estimated by using a multi-view captured image, and a result of a three-dimensional structure analysis of the object. Further, an imaging optical system used to generate the captured image and an illumination optical system used to emit the illumination light perform a zoom operation in synchronization with each other.

According to a second embodiment of the present disclosure, there is provided an image processing method including: separating, from a captured image, an image captured in illumination of a measurement light mode in which an illumination intensity distribution is set to a predetermined spatial distribution; calculating an illumination intensity distribution in a correction light mode in which illumination corresponding to an object is provided, based on the separated image; and performing output control of illumination light based on the calculated illumination intensity distribution.

According to the present disclosure, the image captured in illumination of the measurement light mode in which the illumination intensity distribution is set to a predetermined spatial distribution is separated from the captured image. Based on the separated image, the illumination intensity distribution in the correction light mode in which illumination corresponding to the object is provided is calculated, and output control of illumination light in the correction light mode is performed based on the calculated illumination intensity distribution. Therefore, in the correction light mode, light distribution control with a high spatial resolution corresponding to an object is performed and an imaging operation in illumination of the correction light mode is performed, with the result that a captured image in which blown-out highlights, blocked-up shadows, or the like are not generated can be obtained.

These and other objects, features and advantages of the present disclosure will become more apparent in light of the following detailed description of best mode embodiments thereof, as illustrated in the accompanying drawings.

### BRIEF DESCRIPTION OF DRAWINGS

FIGS. 1A to 1C are diagrams each showing an example of an outer appearance of an imaging apparatus;

FIG. 2 is a diagram showing a configuration example of the imaging apparatus;

FIG. 3 is a flowchart showing operations of the imaging apparatus;

FIG. 4 is a flowchart of illumination intensity calculation/output control;

FIGS. 5A to 5G are timing charts showing operations of the imaging apparatus;

FIGS. 6A and 6B are diagrams showing an example of a captured image generated by illumination in related art and an example of a captured image generated by illumination in a correction light mode according to an embodiment of the present disclosure, respectively;

FIG. 7 is a diagram showing a configuration of Modified Example 1;

FIG. 8 is a diagram showing a configuration of Modified Example 2;

FIG. 9 is a diagram showing a configuration of Modified Example 3;

FIG. 10 is a flowchart showing operations of an imaging apparatus of Modified Example 3;

FIG. 11 is a diagram showing a configuration of Modified Example 4;

FIG. 12 is a diagram showing a configuration of Modified Example 5;

FIG. 13 is a flowchart showing operations of an imaging apparatus of Modified Example 5;

FIGS. 14A to 14I are timing charts showing operations of the imaging apparatus of Modified Example 5;

FIG. 15 is a diagram showing a configuration of Modified Example 6; and

FIGS. 16A to 16C are diagrams each showing a modified example of an optical path of illumination light.

### DETAILED DESCRIPTION OF EMBODIMENTS

Hereinafter, embodiments for carrying out the present disclosure will be described. It should be noted that the description is given in the following order.

1. Outer Appearance of Imaging Apparatus

2. Configuration of Imaging Apparatus

3. Operation of Imaging Apparatus

4. Modified Example 1

5. Modified Example 2

6. Modified Example 3

7. Modified Example 4

8. Modified Example 5

9. Modified Example 6

10. Modified Example 7

(1. Outer Appearance of Imaging Apparatus)

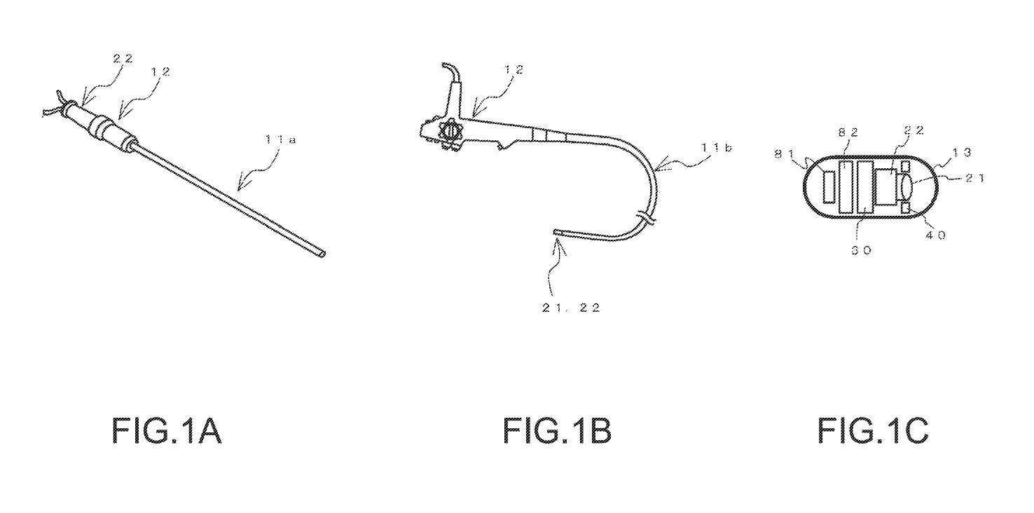

FIGS. 1A to 1C each show an example of the outer appearance of an imaging apparatus including an image processing apparatus according to an embodiment of the present disclosure, for example, an endoscope apparatus. FIG. 1A shows the outer appearance of a rigid endoscope apparatus. FIG. 1B shows the outer appearance of a flexible endoscope apparatus. FIG. 1C shows the internal configuration of a capsule endoscope apparatus.

The rigid endoscope apparatus includes an insertion unit 11a, an operation unit 12, and an imaging unit 22. The insertion unit 11a is inserted into an observation target. The operation unit 12 is grasped by a user. The insertion unit 11a includes an image guide shaft and an illumination guide fiber. Light emitted from a light source unit to be described later is applied to an observation target via the illumination guide fiber and an imaging lens provided at the leading end of the insertion unit 11a. Light from the observation target enters the imaging unit 22 via the imaging lens and a relay lens within the image guide shaft.

As in the rigid endoscope apparatus, the flexible endoscope apparatus also includes an insertion unit 11b, an operation unit 12, and an imaging unit 22. The insertion unit 11b is inserted into an observation target. The operation unit 12 is grasped by a user. The insertion unit 11b of the flexible endoscope apparatus is flexible and includes an imaging optical system 21 and the imaging unit 22 at the leading end thereof.

The capsule endoscope apparatus includes an imaging optical system 21, an imaging unit 22, an illumination controller 30, and an illumination unit 40, for example, in a casing 13. The capsule endoscope apparatus further includes a wireless communication unit 81, a power source unit 82, and the like. The wireless communication unit 81 is used for transmitting a processed image signal, for example.

(2. Configuration of Imaging Apparatus)

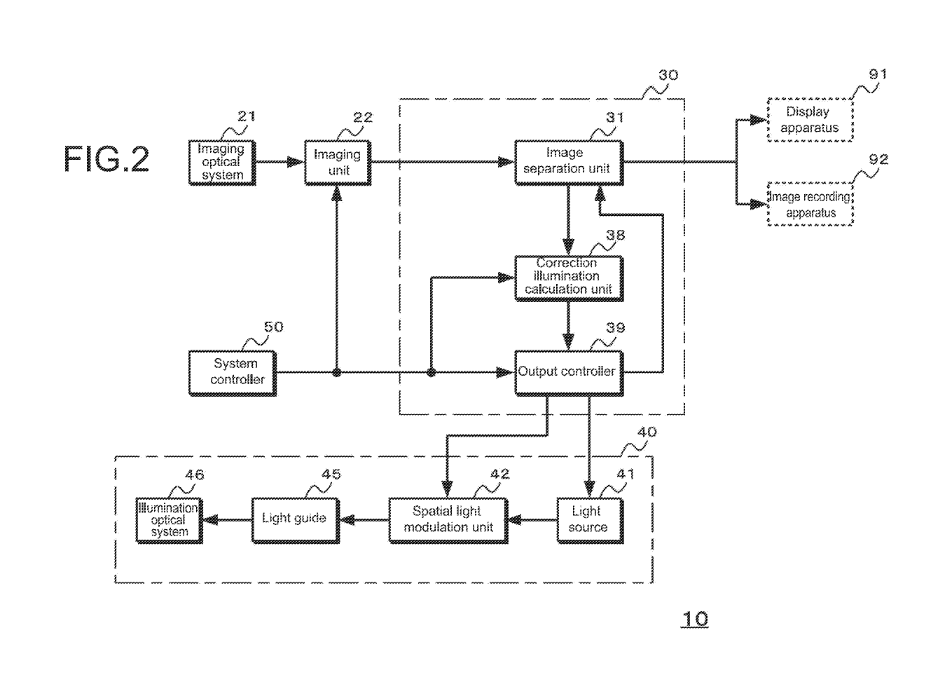

FIG. 2 shows a configuration example of the imaging apparatus, for example, an endoscope apparatus. An imaging apparatus 10 includes an imaging optical system 21, an imaging unit 22, an illumination controller 30, an illumination unit 40, a system controller 50, and the like. Further, the illumination controller 30 includes an image separation unit 31, a correction illumination calculation unit 38, and an output controller 39.

The imaging optical system 21 is constituted of a lens unit for focusing on an object.

The imaging unit 22 is constituted of an imaging device such as a CCD (Charge Coupled Device) image sensor and a CMOS (Complementary Metal-Oxide Semiconductor) image sensor and generates an image signal corresponding to an optical image of the object. Further, the imaging unit 22 synchronizes with the illumination controller 30 and the illumination unit 40 based on a synchronizing signal supplied from the system controller 50 to perform an imaging operation. In addition, the imaging unit 22 may perform various types of processing on the image signal generated in the imaging unit 22 such that a captured image can be displayed or recorded with an excellent image quality. In this case, the imaging unit 22 performs white balance adjustment processing, color correction processing, and edge enhancement processing, and the like. The imaging unit 22 outputs the image signal of the captured image to the image separation unit 31 of the illumination controller 30.

The image separation unit 31 segments the image signal of the captured image in units of screens, for example, at a position of frame switching, based on an illumination mode signal from the output controller 39 to be described later. In the case where the illumination mode signal indicates that illumination is set to a correction light mode, the image separation unit 31 outputs an image signal of an image captured in illumination of the correction light mode to a display apparatus 91 or an image recording apparatus 92, for example. Further, in the case where the illumination mode signal indicates that illumination is set to a measurement light mode, the image separation unit 31 outputs an image signal of an image captured in illumination of the measurement light mode to the correction illumination calculation unit 38. Additionally, in a period of time during which illumination is set to the measurement light mode, the image separation unit 31 performs interpolation processing using the image signal of the image captured in illumination of the correction light mode. The image separation unit 31 performs the interpolation processing to generate an image signal of an image corresponding to the image captured in illumination of the correction light mode and then outputs the image signal to the display apparatus 91 or the image recording apparatus 92, for example.

The correction illumination calculation unit 38 calculates an illumination intensity distribution of illumination light in the correction light mode, based on the image signal of the image captured in illumination of the measurement light mode. In the measurement light mode, illumination light having a uniform illumination intensity distribution is output from the illumination unit 40, as will be described later. In an image captured in such illumination of the measurement light mode, an object part with a high reflectance has high luminance, and an object part with a low reflectance has low luminance. Therefore, the correction illumination calculation unit 38 calculates an illumination intensity distribution of illumination light in the correction light mode such that a captured image in which blown-out highlights, blocked-up shadows, or the like are not generated can be obtained even if the object part with a high reflectance and the object part with a low reflectance are mixed in the imaging range. The correction illumination calculation unit 38 performs a calculation shown in Expression (1) below, for example, to calculate an illumination intensity distribution. It should be noted that “k” is a constant in Expression (1).

Illumination Intensity=k(1/luminance of object) (1)

Incidentally, in the case where the illumination unit 40 to be described later has a spatial resolution lower than that of the captured image, for example, even if an illumination intensity is calculated for each of a pixel position of the captured image, illumination light corresponding to a distribution of the calculated illumination intensity is difficult to be output. In this regard, the image separation unit 31 performs resolution conversion processing on the image captured in illumination of the measurement light mode and calculates an illumination intensity distribution at a resolution corresponding to the spatial resolution of the illumination unit 40, thus reducing the amount of calculation. For example, the correction illumination calculation unit 38 performs low-pass filter processing as the resolution conversion processing on the image signal of the captured image from the image separation unit 31 and calculates an illumination intensity distribution based on the image whose resolution is reduced.

The output controller 39 switches the illumination mode to the measurement light mode or to the correction light mode based on a control signal from the system controller 50. Further, the output controller 39 generates an illumination mode signal indicating to which of the measurement light mode and the correction light mode the illumination mode is set, and outputs the illumination mode signal to the image separation unit 31. Further, the output controller 39 generates an illumination control signal based on a calculation result of the illumination intensity distribution in the correction illumination calculation unit 38 and outputs the illumination control signal to the illumination unit 40. Thus, the output controller 39 controls the illumination intensity of the illumination light in the correction light mode. Further, in the measurement light mode, the output controller 39 generates an illumination control signal for outputting illumination light having a uniform illumination intensity distribution and outputs the illumination control signal to the illumination unit 40.

The illumination unit 40 includes a light source 41, a spatial light modulation unit 42, a light guide 45, and an illumination optical system 46.

The light source 41 is constituted of a light-emitting device such as a xenon lamp, a white LED (Light Emitting Diode), and a high-luminance white light source using a GaN semiconductor laser. The light source 41 outputs illumination light, which is output from the light-emitting device, to the spatial light modulation unit 42.

The spatial light modulation unit 42 is constituted of a light modulation device such as a transmissive liquid crystal panel, a reflective liquid crystal panel (LCOS (Liquid crystal on silicon)), and a DMD (Digital Micromirror Device). The spatial light modulation unit 42 controls the transmission or reflection of the illumination light in the light modulation device to adjust the illumination intensity, based on the illumination control signal from the output controller 39. For example, in the case where the illumination mode is the measurement light mode, the spatial light modulation unit 42 sets a uniform illumination intensity distribution of the illumination light. Further, in the case where illumination mode is the correction light mode, the spatial light modulation unit 42 sets an illumination intensity distribution of the illumination light, which is calculated in the correction illumination calculation unit 38.

Illumination light, the illumination intensity of which is adjusted in the spatial light modulation unit 42, is supplied to the illumination optical system 46 via the light guide 45. The illumination optical system 46 applies the illumination light supplied via the light guide 45 to the object.

The system controller 50 operates the imaging unit 22, the illumination controller 30, and the illumination unit 40 in synchronization with one another. Specifically, the system controller 50 switches the illumination mode in synchronization with a frame switching timing such that the image captured in illumination of the measurement light mode and the image captured in illumination of the correction light mode are not mixed in one frame. It should be noted that instead of the output controller 39, the system controller 50 may select the illumination mode of each frame from the measurement light mode and the correction light mode. Further, the system controller 50 (including modified examples to be described later) corresponds to an operation controller in the section “What is claimed is”.

(3. Operation of Imaging Apparatus)

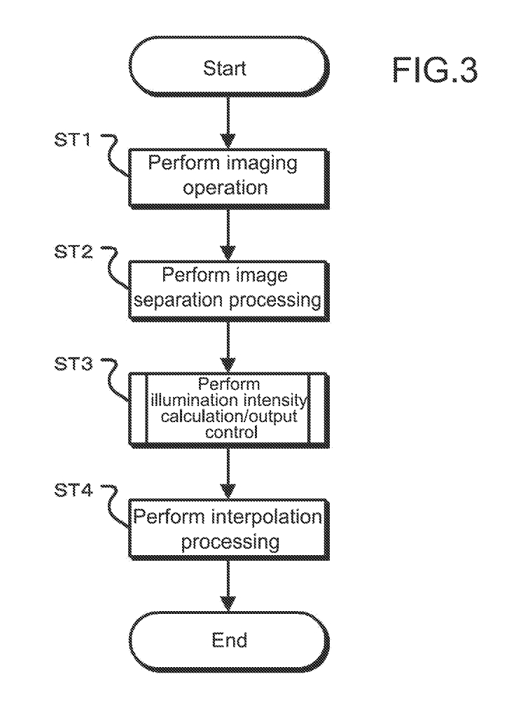

FIG. 3 is a flowchart showing operations of the imaging apparatus. In Step ST1, the imaging apparatus 10 performs an imaging operation. The imaging apparatus 10 captures an image of an object, generates a moving image, and proceeds to Step ST2.

In Step ST2, the imaging apparatus 10 performs image separation processing. The imaging apparatus 10 separates a frame of an image captured in illumination of the measurement light mode from a frame of an image captured in illumination of the correction light mode, and then proceeds to Step ST3.

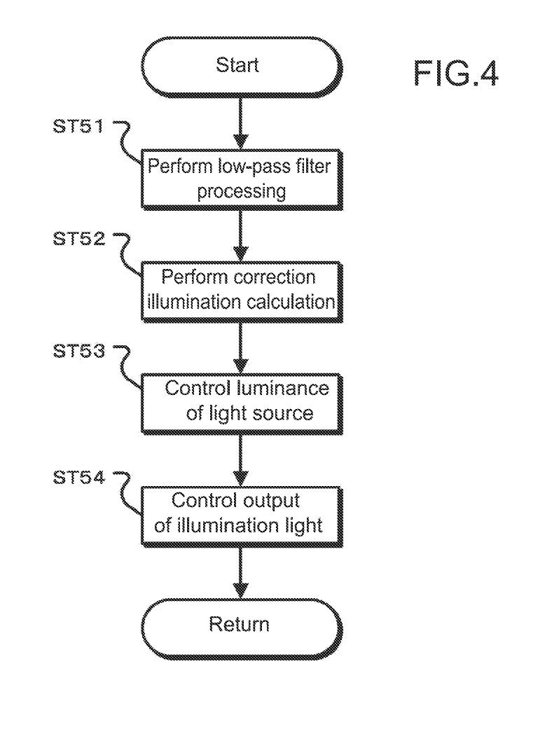

In Step ST3, the imaging apparatus 10 performs illumination intensity calculation/output control. FIG. 4 is a flowchart showing the illumination intensity calculation/output control. In Step ST51, the imaging apparatus 10 performs low-pass filter processing. The imaging apparatus 10 performs low-pass filter processing on the image captured in illumination of the measurement light mode to enable an illumination intensity distribution to be calculated at a resolution corresponding to the spatial resolution of the illumination unit 40. Then, the imaging apparatus 10 proceeds to Step ST52.

In Step ST52, the imaging apparatus 10 performs correction illumination calculation. The imaging apparatus 10 calculates an illumination intensity distribution of illumination light in the correction light mode based on the image signal that has been subjected to the low-pass filter processing. The imaging apparatus 10 calculates an illumination intensity distribution such that a captured image in which blown-out highlights, blocked-up shadows, or the like are not generated can be obtained even if an object part with a high reflectance, an object part with a low reflectance, and the like are mixed in the imaging range. Then, the imaging apparatus 10 proceeds to Step ST53.

In Step ST53, the imaging apparatus 10 controls luminance of a light source. The imaging apparatus 10 controls an emission operation of the light source 41 such that illumination light emitted from the light source 41 can have a predetermined light intensity. Then, the imaging apparatus 10 proceeds to Step ST54.

In Step ST54, the imaging apparatus 10 controls output of illumination light. In the case where the illumination mode is set to the measurement light mode, the imaging apparatus 10 controls output of illumination light such that the illumination intensity distribution is uniform. Further, in the case where the illumination mode is set to the correction light mode, the imaging apparatus 10 controls output of illumination light such that the illumination light has an illumination intensity distribution calculated in Step ST52, and returns to Step ST3 of FIG. 3.

When the illumination intensity calculation/output control is performed in Step ST3 and the processing proceeds to Step ST4, the imaging apparatus 10 performs interpolation processing. The imaging apparatus 10 generates an image signal of an image corresponding to the image captured in illumination of the correction light mode by the interpolation processing or the like. The image signal is generated based on the image signal of the image captured in illumination of the correction light mode, with respect to a period of time during which the illumination is provided in the measurement light mode. Further, the imaging apparatus 10 outputs the image signal of the image captured in illumination of the correction light mode and the image signal of the captured image that is generated by the interpolation processing or the like in a period of time during which the measurement light mode is set, to the display apparatus 91, the image recording apparatus 92, or the like.

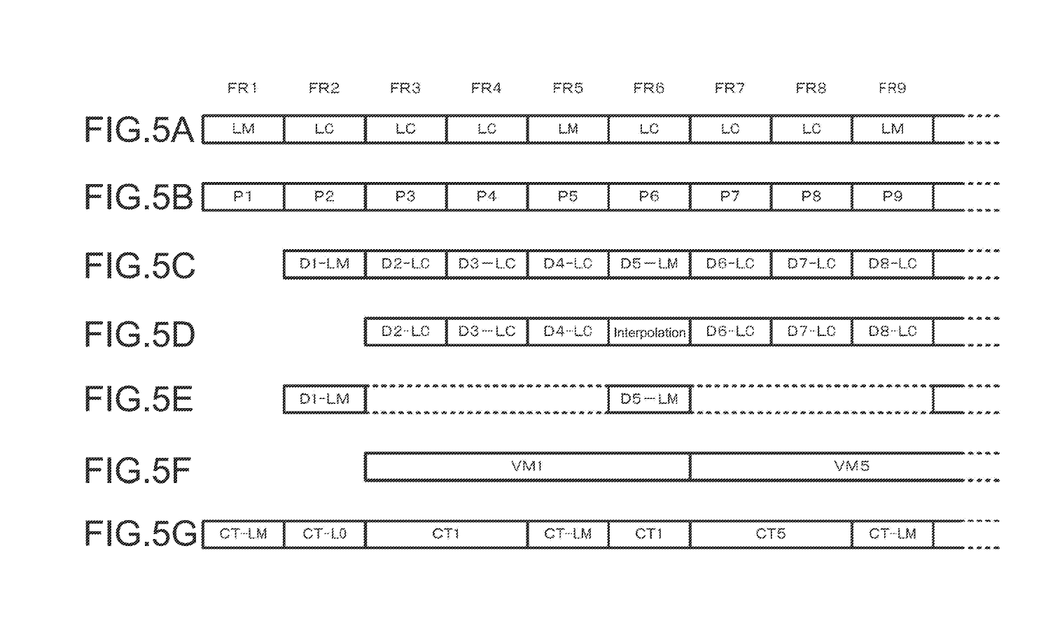

FIGS. 5A to 5G are timing charts each showing an operation of the imaging apparatus. FIG. 5A shows the illumination mode. FIG. 5B shows frames in an imaging operation. FIG. 5C shows frames of image signals supplied to the image separation unit 31. FIG. 5D shows frames of image signals output from the image separation unit 31. FIG. 5E shows frames of image signals supplied to the correction illumination calculation unit 38. FIG. 5F shows calculation results of an illumination intensity distribution. FIG. 5G shows illumination control signals.

Based on the illumination control signal from the output controller 39, for example, the illumination unit 40 provides illumination in the measurement light mode in only one frame period and then provides illumination in the correction light mode in the following three frame periods. Further, when the illumination in the correction light mode is finished, illumination in the measurement light mode is provided again in only one frame period. After that, the illumination mode is switched in the same manner.

In the case where the imaging apparatus 10 sets the illumination mode to the measurement light mode (LM) in the first frame FR1 as shown in FIG. 5A, for example, the imaging apparatus 10 outputs a signal “CT-LM” serving as an illumination control signal from the output controller 39 to the illumination unit 40 as shown in FIG. 5G. It should be noted that the signal “CT-LM” is a signal for outputting the illumination light in the measurement light mode from the illumination unit 40. Further, the imaging unit 22 performs an imaging operation P1 on an object illuminated in the measurement light mode.

In the case where the imaging apparatus 10 sets the illumination mode to the correction light mode (LC) in the second frame FR2 as shown in FIG. 5A, the imaging apparatus 10 outputs a signal “CT-L0” serving as an illumination control signal from the output controller 39 to the illumination unit 40 as shown in FIG. 5G. In this case, the illumination intensity distribution of the illumination light in the correction light mode is not completely calculated, and therefore the output controller 39 outputs the signal “CT-L0” in which the illumination intensity is an initial value. The imaging unit 22 performs an imaging operation P2 on the object illuminated in the correction light mode. Further, the imaging unit 22 supplies an image signal “D1-LM”, which is generated in the imaging operation P1, to the image separation unit 31 as shown in FIG. 5C. Here, the image signal supplied from the imaging unit 22 is the image signal obtained when the object illuminated in the measurement light mode is imaged. Therefore, the image separation unit 31 supplies the image signal “D1-LM” to the correction illumination calculation unit 38 as shown in FIG. 5E to calculate an illumination intensity distribution based on the image signal “D1-LM”.

In the case where the imaging apparatus 10 sets the illumination mode to the correction light mode (LC) in the third frame FR3 as shown in FIG. 5A, the imaging apparatus 10 outputs a signal “CT1” serving as an illumination control signal from the output controller 39 to the illumination unit 40 as shown in FIG. 5G. Here, it is assumed that the correction illumination calculation unit 38 calculates an illumination intensity distribution in the correction light mode based on the image signal “D1-LM” and obtains a calculation result “VM1” as shown in FIG. 5F. In this case, the output controller 39 generates the signal “CT1” based on the calculation result “VM1” and outputs the signal “CT1” to the illumination unit 40. Therefore, the imaging unit 22 can obtain an excellent captured image in which blown-out highlights, blocked-up shadows, or the like are not generated, when performing an imaging operation P3 on the object illuminated in the correction light mode. Further, as shown in FIG. 5C, the imaging unit 22 outputs an image signal “D2-LC”, which is generated in the imaging operation P2, to the image separation unit 31. Since the image signal supplied from the imaging unit 22 is the image signal obtained when the object illuminated in the correction light mode is imaged, the image separation unit 31 outputs the image signal “D2-LC” to the display apparatus 91 or the image recording apparatus 92.

After that, in the case where the imaging apparatus 10 sets the illumination mode to the measurement light mode (LM) in the fifth frame FR5 as shown in FIG. 5A, the imaging apparatus 10 outputs a signal “CT-LM” serving as an illumination control signal from the output controller 39 to the illumination unit 40 as shown in FIG. 5G. Further, the imaging unit 22 performs an imaging operation P5 on the object illuminated in the measurement light mode.

In the case where the imaging apparatus 10 sets the illumination mode to the correction light mode (LC) in the sixth frame FR6 as shown in FIG. 5A, the imaging apparatus 10 outputs a signal “CT1” serving as an illumination control signal from the output controller 39 to the illumination unit 40 as shown in FIG. 5G. Further, in the frame FR6, the imaging unit 22 outputs an image signal “D5-LM”, which is generated in the imaging operation P5 as shown in FIG. 5C, to the image separation unit 31. Here, the image signal supplied from the imaging unit 22 is the image signal obtained when the object illuminated in the measurement light mode is imaged. Therefore, the image separation unit 31 supplies the image signal “D5-LM” to the correction illumination calculation unit 38 and calculates an illumination intensity distribution based on the image signal “D5-LM” as shown in FIG. 5E. Further, in the case where the image signal supplied to the image separation unit 31 is the image signal obtained when the object illuminated in the measurement light mode is imaged, the image signal to be output to the display apparatus 91 or the image recording apparatus 92 is absent. Therefore, the image separation unit 31 performs interpolation processing or the like using the image signal obtained when the object illuminated in the measurement light mode is imaged, and outputs the generated image signal to the display apparatus 91 or the image recording apparatus 92 during the period of the frame FR6.

Various methods can be used for the interpolation processing. For example, in a first interpolation processing method, an image signal of a frame located immediately before is repeatedly used. For example, an image signal “D4-LC” is output also in a period of the frame FR6. In a second interpolation processing method, motion vectors of respective blocks are calculated from a plurality of past frames, and the calculated motion vectors are used to generate a motion-compensated image. For example, an image signal “D3-LC” and an image signal “D4-LC” are used to calculate motion vectors, motion compensation is performed for the image signal “D4-LC” by using the calculated motion vectors, and an image signal of a motion-compensated image corresponding to the frame FR6 is generated. The generated image signal is output during the period of the frame FR6. In a third interpolation processing method, motion vectors of respective blocks are calculated from past and future frames, and the calculated motion vectors are used to generate a motion-compensated image. For example, an image signal “D4-LC” and an image signal “D6-LC” are used to calculate motion vectors, the calculated motion vectors are used to perform motion compensation of the image signal “D4-LC” or the image signal “D6-LC”, and an image signal of an motion-compensated image is output during the period of the frame FR6. It should be noted that in the third interpolation processing method, the motion-compensated image is generated from the past and future frames, with the result that highly accurate interpolation processing can be performed. However, since the image signal of a future frame is used, an image signal to be output to the display apparatus 91 or the image recording apparatus 92 has a large delay. It should be noted that the interpolation processing method is not limited to the above-mentioned methods and other methods may be used.

In the case where the imaging apparatus 10 sets the illumination mode to the correction light mode (LC) in the seventh frame FR7 as shown in FIG. 5A, the imaging apparatus 10 outputs a signal “CT5” serving as an illumination control signal from the output controller 39 to the illumination unit 40 as shown in FIG. 5G. Here, it is assumed that the correction illumination calculation unit 38 calculates an illumination intensity distribution based on the image signal “D5-LM” and a calculation result “VM5” is obtained as shown in FIG. 5F. In this case, the output controller 39 generates the signal “CT5” based on the calculation result “VM5” and outputs the signal “CT5” to the illumination unit 40. Therefore, the imaging unit 22 can obtain an excellent captured image in which blown-out highlights, blocked-up shadows, or the like are not generated, when performing an imaging operation P7 on the object illuminated in the correction light mode. Further, the imaging unit 22 outputs an image signal “D6-LC”, which is generated in the imaging operation P6 as shown in FIG. 5C, to the image separation unit 31. Since the image signal supplied from the imaging unit 22 is the image signal obtained when the object illuminated in the correction light mode is imaged, the image separation unit 31 outputs the image signal “D6-LC” to the display apparatus 91 or the image recording apparatus 92.

The imaging apparatus 10 performs the processing as described above and outputs an excellent captured image in which blown-out highlights, blocked-up shadows, or the like are not generated to the display apparatus 91 or the image recording apparatus 92.

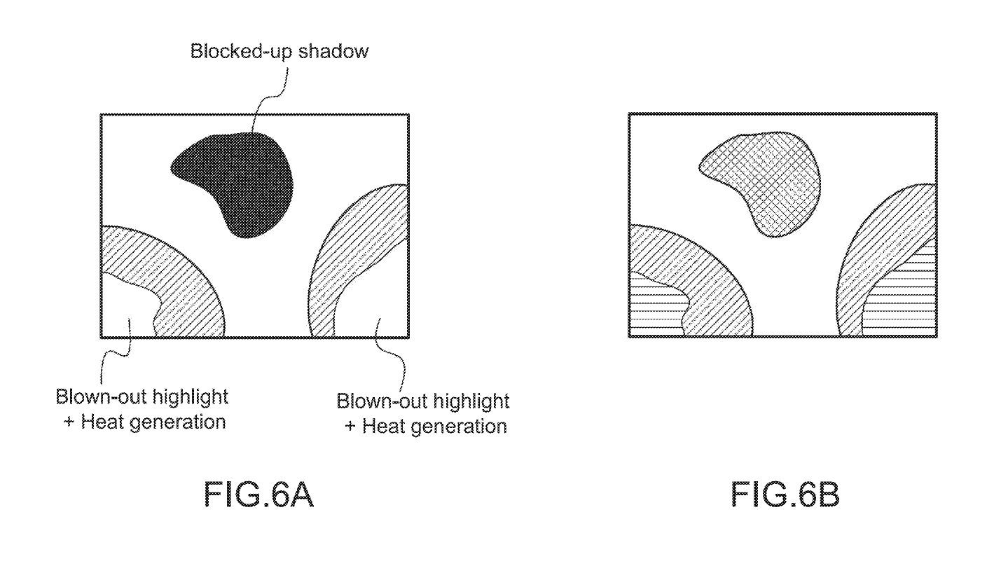

FIGS. 6A and 6B show an example of an captured image generated by illumination in related art and an example of a captured image generated by the illumination in the correction light mode according to the embodiment of the present disclosure, respectively. In the captured image generated by illumination in related art, as shown in FIG. 6A, for example, an object part with a high reflectance has a blown-out highlight and an object part with a low reflectance has a blocked-up shadow in some cases. Further, there is a case where the object part with a high reflectance is heated by the illumination light. However, when the above processing is performed, in the illumination in the correction light mode, the illumination intensity of the object part with a high reflectance is reduced and the illumination intensity of the object part with a low reflectance is increased. Therefore, as shown in FIG. 6B, no blown-out highlights are generated in the object part with a high reflectance, and no blocked-up shadows are generated in the object part with a low reflectance. Thus, an excellent image can be obtained.

As described above, the imaging apparatus 10 distinguishes an object part with a high reflectance from an object part with a low reflectance based on an image captured in illumination of the measurement light mode. Further, the imaging apparatus 10 adjusts the illumination intensity such that the illumination intensity of the object part with a high reflectance is reduced and the illumination intensity of the object part with a low reflectance is increased in the correction light mode. Therefore, even if there are an object part with a high reflectance, an object part with a low reflectance, and the like in the imaging range, the imaging apparatus 10 can provide an image captured in illumination of the measurement light mode as an excellent captured image in which blown-out highlights, blocked-up shadows, or the like are not generated.

Further, the imaging apparatus 10 periodically performs the imaging operation in the measurement light mode and calculates an illumination intensity distribution in the correction light mode based on the image signal generated by the imaging operation in the measurement light mode. Therefore, even in the case where an object moves or the status of the object changes during the imaging, the illumination intensity distribution in the correction light mode is automatically adjusted following the movement of the object or the change of status thereof. Therefore, the imaging apparatus 10 can easily obtain an excellent captured image in which blown-out highlights, blocked-up shadows, or the like are not generated, irrespective of the change of the object. Furthermore, the imaging apparatus 10 can prevent the object from generating heat due to the illumination light, for example. In addition, in the case where the illumination unit 40 has a lower spatial resolution than that of the captured image, the imaging apparatus 10 calculates the illumination intensity distribution at a resolution corresponding to the spatial resolution of the illumination unit 40. Therefore, the amount of calculation for the illumination intensity distribution can be reduced, with the result that the reduction in power consumption is achieved and heat generation due to the calculation operation in the illumination controller 30 is reduced.

### 4. Modified Example 1

Incidentally, the illumination unit according to the embodiment described above exemplifies a configuration to modulate illumination light emitted from a light source in the spatial light modulation unit and adjust the illumination intensity in accordance with the reflectance of the object. However, if the illumination unit is constituted of a light-emitting device, the configuration of the illumination unit can be simplified because the light source and the spatial light modulation unit are not necessarily separate from each other.

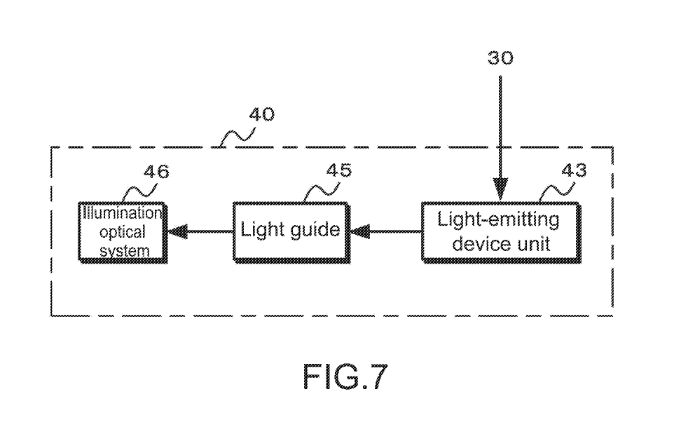

In Modified Example 1, a case where the illumination unit is constituted of a light-emitting device will be described. FIG. 7 shows a configuration of Modified Example 1. An illumination unit 40 of Modified Example 1 includes a light-emitting device unit 43, a light guide 45, and an illumination optical system 46.

The light-emitting device unit 43 is constituted of a light-emitting device such as an OLED (Organic Light-Emitting Diode). The light-emitting device unit 43 adjusts the illumination intensity of illumination light to be emitted based on the illumination control signal from the output controller 39. For example, in the case where the illumination mode is the measurement light mode, the light-emitting device unit 43 sets the illumination intensity distribution of the illumination light to be uniform. Further, in the case where the illumination mode is the correction light mode, the light-emitting device unit 43 sets the illumination intensity distribution of the illumination light to be a distribution calculated in the correction illumination calculation unit 38.

The illumination light emitted from the light-emitting device unit 43 is supplied to the illumination optical system 46 via the light guide 45. The illumination optical system 46 irradiates the object with the illumination light supplied via the light guide 45.

In this manner, if the light-emitting device is used for illumination, the configuration of the illumination unit can be made simpler than that of an illumination unit constituted of a light source and a spatial light modulation unit. Further, in the case where the light-emitting device serves as a spatial light modulation unit to adjust a transmittance and an illumination intensity, heat is generated in the spatial light modulation unit due to absorption of light not transmitted. For that reason, for example, the spatial light modulation unit has to be provided to a position outside the body. However, the use of a light-emitting device excellent in light conversion efficiency allows the amount of generated heat of the illumination unit to be reduced. Thus, the illumination unit can be provided in the body, and the degree of freedom of the configuration of the imaging apparatus 10 can be enhanced.

### 5. Modified Example 2

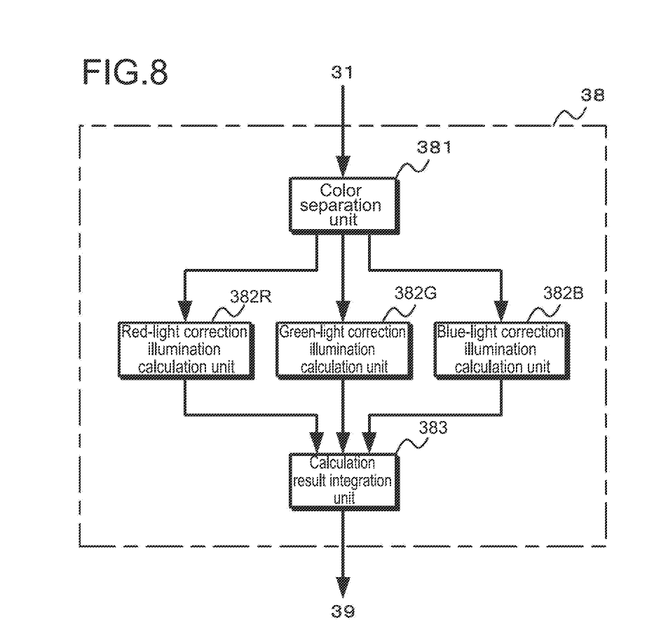

Modified Example 2 shows an example of another configuration of the correction illumination calculation unit. FIG. 8 shows a configuration of Modified Example 2. A correction illumination calculation unit 38 in Modified Example 2 includes a color separation unit 381, a red-light correction illumination calculation unit 382R, a green-light correction illumination calculation unit 382G, a blue-light correction illumination calculation unit 382B, and a calculation result integration unit 383.

The color separation unit 381 performs color separation processing on the image signal supplied from the image separation unit 31 and generates red-, green-, and blue-color component signals, for example. The color separation unit 381 outputs the generated red-color component signal to the red-light correction illumination calculation unit 382R. Further, the color separation unit 381 outputs the generated green-color component signal to the green-light correction illumination calculation unit 382G and outputs the generated blue-color component signal to the blue-light correction illumination calculation unit 382B.

The red-light correction illumination calculation unit 382R performs correction illumination calculation based on the red-color component signal and outputs a calculation result to the calculation result integration unit 383. The green-light correction illumination calculation unit 382G performs correction illumination calculation based on the green-color component signal and outputs a calculation result to the calculation result integration unit 383. The blue-light correction illumination calculation unit 382B performs correction illumination calculation based on the blue-color component signal and outputs a calculation result to the calculation result integration unit 383.

The calculation result integration unit 383 calculates an illumination intensity distribution in which saturation or shadows are not generated for each color component, based on the calculation results of the red-light correction illumination calculation unit 382R, the green-light correction illumination calculation unit 382G, and the blue-light correction illumination calculation unit 382B, to output calculation results to the output controller 39.

In this manner, the correction illumination calculation unit 38 calculates an illumination intensity distribution for each color component. Therefore, in the imaging apparatus of Modified Example 2, it is possible to adjust the illumination light to have an optimal illumination intensity so that color saturation or color cast is not caused in a desired color of an object to be observed, for example.

### 6. Modified Example 3

Modified Example 3 shows a case of calculating an illumination intensity distribution in the correction illumination calculation unit 38 by using distance information indicating a distance to each object located in the imaging range.

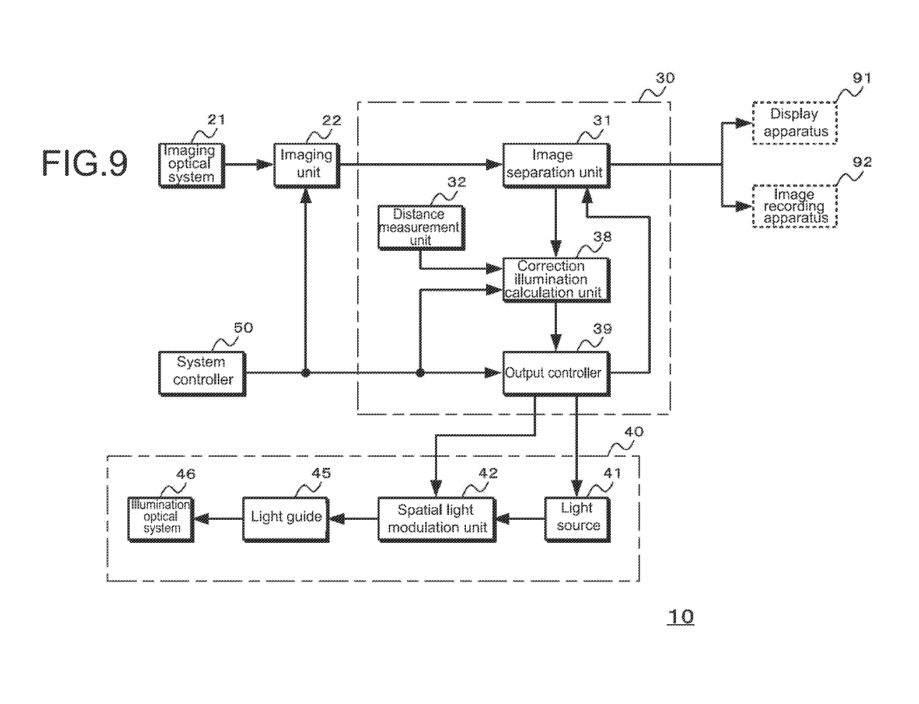

FIG. 9 shows a configuration of Modified Example 3. An imaging apparatus 10 of Modified Example 3 includes an imaging optical system 21, an imaging unit 22, an illumination controller 30, an illumination unit 40, and a system controller 50. Additionally, the illumination controller 30 includes an image separation unit 31, a distance measurement unit 32, a correction illumination calculation unit 38, and an output controller 39.

The imaging optical system 21 is constituted of a lens unit for focusing on an object.

The imaging unit 22 is constituted of an imaging device such as a CCD (Charge Coupled Device) image sensor and a CMOS (Complementary Metal-Oxide Semiconductor) image sensor and generates an image signal corresponding to an optical image of the object. Further, the imaging unit 22 synchronizes with the illumination unit 40 based on a synchronizing signal supplied from the system controller 50 to perform an imaging operation. In addition, the imaging unit 22 performs various types of processing on the generated image signal.

The image separation unit 31 segments the image signal of the captured image in units of screens, for example, at a position of frame switching, based on an illumination mode signal from the output controller 39. In the case where the illumination mode signal indicates that illumination is set to a correction light mode, the image separation unit 31 outputs an image signal of an image captured in illumination of the correction light mode to a display apparatus 91 or an image recording apparatus 92, for example. Further, in the case where the illumination mode signal indicates that illumination is set to a measurement light mode, the image separation unit 31 outputs an image signal of an image captured in illumination of the measurement light mode to the correction illumination calculation unit 38. In addition, the image separation unit 31 performs interpolation processing using the image signal of the image captured in illumination of the correction light mode in a period of time during which illumination is set to the measurement light mode. The image separation unit 31 performs the interpolation processing to generate an image signal of an image corresponding to the image captured in illumination of the correction light mode and then outputs the image signal to the display apparatus 91 or the image recording apparatus 92, for example.

The distance measurement unit 32 calculates a distance to an object part located in the imaging range. The distance measurement unit 32 calculates distances to an object from a plurality of positions in the imaging range. For example, the distance measurement unit 32 irradiates the object with infrared rays as in the case of using a TOF (Time of Flight) camera and calculates a distance based on time spent until reflected infrared rays are incident on the camera. Further, an imaging device including a distance measurement pixel may be used as the imaging unit 22 to calculate a distance by using a signal of the distance measurement pixel. The distance measurement unit 32 outputs a measurement result of the distance to the correction illumination calculation unit 38.

The correction illumination calculation unit 38 calculates an illumination intensity distribution of illumination light in the correction light mode, based on the measurement result of the distance from the distance measurement unit 32 and the image signal of the image captured in illumination of the measurement light mode. In the measurement light mode, illumination light having a uniform illumination intensity distribution is output from the illumination unit 40. In an image captured in such illumination of the measurement light mode, an object part with a high reflectance or a close object part has high luminance, and an object part with a low reflectance or a distant object part has low luminance. Therefore, the correction illumination calculation unit 38 calculates an illumination intensity distribution of illumination light in the correction light mode such that a captured image in which blown-out highlights, blocked-up shadows, or the like are not generated can be obtained even if object parts with different reflectances and object parts having different distances are mixed in the imaged range. The correction illumination calculation unit 38 performs the calculation shown in Expression (1), for example, to calculate an illumination intensity distribution.

It is known that the brightness of an object is inversely proportional to the square of a distance, and therefore the correction illumination calculation unit 38 adjusts the illumination intensity based on the measurement result of the distance. For example, the correction illumination calculation unit 38 performs a calculation shown in Expression (2) in the case of the measurement light mode and provides illumination at an illumination intensity calculated in accordance with a distance to the object in a uniform illumination intensity distribution. Further, the correction illumination calculation unit 38 performs a calculation shown in Expression (3) in the case of the correction light mode, to calculate an illumination intensity in which the distance is considered. It should be noted that “k” is a constant.

Illumination Intensity=k(square of distance) (2)

Illumination Intensity=k(1/luminance of object)(square of distance) (3)

Further, the correction illumination calculation unit 38 may calculate an illumination intensity based on only a distance measured without using the measurement light mode. In this case, Expression (4) is used for calculation. It should be noted that “kc” is a constant in the correction light mode.

Illumination Intensity=kc(square of distance) (4)

The output controller 39 switches the illumination mode to the measurement light mode or to the correction light mode based on a control signal from the system controller 50. Further, the output controller 39 generates an illumination mode signal indicating to which of the measurement light mode and the correction light mode the illumination mode is set, and outputs the illumination mode signal to the image separation unit 31. Further, the output controller 39 generates an illumination control signal based on a calculation result of the illumination intensity distribution in the correction illumination calculation unit 38 and outputs the illumination control signal to the illumination unit 40. Thus, the output controller 39 controls the illumination intensity of the illumination light in the correction light mode. Further, in the measurement light mode, the output controller 39 generates an illumination control signal for outputting illumination light having a uniform illumination intensity distribution and outputs the illumination control signal to the illumination unit 40.

The illumination unit 40 includes a light source 41, a spatial light modulation unit 42, a light guide 45, and an illumination optical system 46. The illumination unit 40 modulates illumination light emitted from the light source 41 in the spatial light modulation unit 42 based on the illumination control signal from the output controller 39 and irradiates the object with the illumination light whose illumination intensity is adjusted, via the light guide 45 and the illumination optical system 46.

The system controller 50 operates the imaging unit 22, the illumination controller 30, and the illumination unit 40 in synchronization with one another. Specifically, the system controller 50 switches the illumination mode in synchronization with a frame switching timing such that an image captured in illumination of the measurement light mode and an image captured in illumination of the correction light mode are not mixed in one frame. It should be noted that instead of the output controller 39, the system controller 50 may select the illumination mode of each frame from the measurement light mode and the correction light mode.

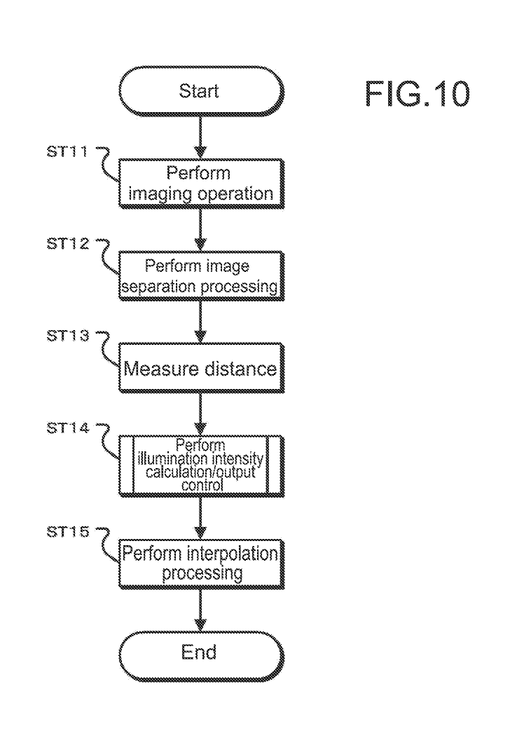

FIG. 10 is a flowchart showing operations of the imaging apparatus of Modified Example 3. In Step ST11, the imaging apparatus 10 performs an imaging operation. The imaging apparatus 10 captures an image of an object, generates a moving image, and proceeds to Step ST12.

Step ST12, the imaging apparatus 10 performs image separation processing. The imaging apparatus 10 separates a frame of an image captured in illumination of the measurement light mode from a frame of an image captured in illumination of the correction light mode, and then proceeds to Step ST13.

In Step ST13, the imaging apparatus 10 measures a distance. The imaging apparatus 10 measures a distance to the object and proceeds to Step ST14.

In Step ST14, the imaging apparatus 10 performs illumination intensity calculation/output control. The imaging apparatus 10 performs the processing of the flowchart shown in FIG. 4 to calculate an illumination intensity distribution. Then, the imaging apparatus 10 performs illumination light output control so that the calculated illumination intensity distribution is set. Then, the imaging apparatus 10 proceeds to Step ST15.

In Step ST15, the imaging apparatus 10 performs interpolation processing. The imaging apparatus 10 performs interpolation processing by using the image signal of the image captured in illumination of the correction light mode and then generates an image signal of an image corresponding to the image captured in illumination of the correction light mode, with respect to a period of time during which the illumination is provided in the measurement light mode. Further, the imaging apparatus 10 outputs the image signal of the image captured in illumination of the correction light mode and the image signal of the captured image that is generated by the interpolation processing or the like in a period of time during which the measurement light mode is set, to the display apparatus 91, the image recording apparatus 92, or the like.

In this manner, the correction illumination calculation unit 38 calculates an illumination intensity distribution in consideration of the distance to the object. Therefore, it is possible to adjust the illumination light to have an optimal illumination intensity with respect to both an object at a close position and an object at a distant position.

### 7. Modified Example 4

Modified Example 4 shows a case of performing so-called passive measurement using a multi-view camera as the imaging unit 22 and estimating a distance to an object without using the distance measurement unit 32. It should be noted that a case of using a stereo camera as the multi-view camera will be described below.

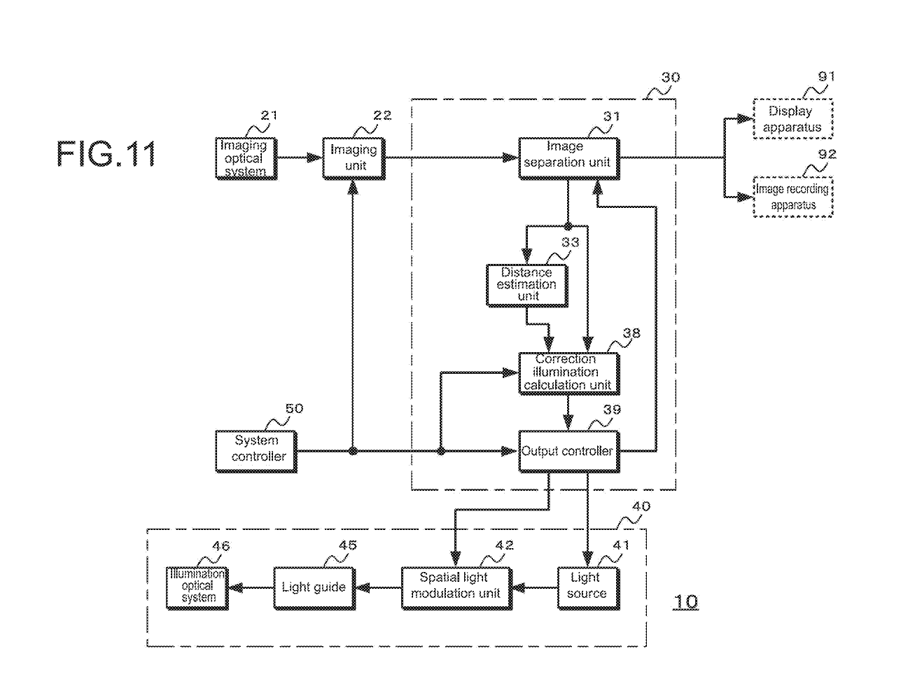

FIG. 11 shows a configuration of Modified Example 4. An imaging apparatus 10 of Modified Example 4 includes an imaging optical system 21, an imaging unit 22, an illumination controller 30, an illumination unit 40, and a system controller 50. Additionally, the illumination controller 30 includes an image separation unit 31, a distance estimation unit 33, a correction illumination calculation unit 38, and an output controller 39.

The imaging optical system 21 is constituted of a lens unit for focusing on an object. It should be noted that the lens unit includes a right-eye unit and a left-eye unit.

The imaging unit 22 is constituted of an imaging device that generates an image signal of a right-eye image and an imaging device that generates an image signal of a left-eye image. Examples of the imaging devices include a CCD (Charge Coupled Device) image sensor and a CMOS (Complementary Metal-Oxide Semiconductor) image sensor. Further, the imaging unit 22 synchronizes with the illumination unit 40 based on a synchronizing signal supplied from the system controller 50 to perform an imaging operation. In addition, the imaging unit 22 performs various types of processing on the generated image signal.

The image separation unit 31 segments the image signal of the captured image in units of screens, for example, at a position of frame switching, based on an illumination mode signal from the output controller 39. In the case where the illumination mode signal indicates that illumination is set to a correction light mode, the image separation unit 31 outputs an image signal of an image captured in illumination of the correction light mode to a display apparatus 91 or an image recording apparatus 92, for example. Image signals to be output may be only the image signal of the right-eye image or the image signal of the left-eye image, or may be both the image signals of the right-eye image and the left-eye image. Furthermore, in the case where the illumination mode signal indicates that illumination is set to a measurement light mode, the image separation unit 31 outputs an image signal of an image captured in illumination of the measurement light mode to the distance estimation unit 33. The image separation unit 31 outputs the image signals of the right-eye image and the left-eye image to the distance estimation unit 33 as the image signals of the images captured in illumination of the measurement light mode. Moreover, the image separation unit 31 outputs one or both of the image signal of the right-eye image and the image signal of the left-eye image to the correction illumination calculation unit 38. In addition, the image separation unit 31 performs interpolation processing using the image signal of the image captured in illumination of the correction light mode in a period of time during which illumination is set to the measurement light mode. The image separation unit 31 performs the interpolation processing to generate an image signal of an image corresponding to the image captured in illumination of the correction light mode and then outputs the image signal to the display apparatus 91 or the image recording apparatus 92, for example.

The distance estimation unit 33 estimates a distance to the object by passive stereo measurement, for example. The distance estimation unit 33 calculates an amount of parallax using the image signal of the right-eye image and the image signal of the left-eye image. Further, the distance estimation unit 33 estimates a distance to the object by triangulation based on a base line length and the amount of parallax. The base line length is an interval between the imaging unit of the right-eye image and the imaging unit of the left-eye image.

The correction illumination calculation unit 38 calculates an illumination intensity distribution of illumination light in the correction light mode, based on the estimation result of the distance from the distance estimation unit 33 and the image signal of the image captured in illumination of the measurement light mode. In the measurement light mode, illumination light having a uniform illumination intensity distribution is output from the illumination unit 40. In an image captured in such illumination of the measurement light mode, an object part with a high reflectance or a close object part has high luminance, and an object part with a low reflectance or a distant object part has low luminance. Therefore, the correction illumination calculation unit 38 calculates an illumination intensity distribution of illumination light in the correction light mode such that a captured image in which blown-out highlights, blocked-up shadows, or the like are not generated can be obtained even if object parts with different reflectances and object parts having different distances are mixed in the imaged range. The correction illumination calculation unit 38 adjusts the illumination intensity in consideration of the distance to the object as in Modified Example 3.

The output controller 39 switches the illumination mode to the measurement light mode or to the correction light mode based on a control signal from the system controller 50. Further, the output controller 39 generates an illumination mode signal indicating to which of the measurement light mode and the correction light mode the illumination mode is set, and outputs the illumination mode signal to the image separation unit 31. Further, the output controller 39 generates an illumination control signal based on a calculation result of the illumination intensity distribution in the correction illumination calculation unit 38 and outputs the illumination control signal to the illumination unit 40. Thus, the output controller 39 controls the illumination intensity of the illumination light in the correction light mode. Further, in the measurement light mode, the output controller 39 generates an illumination control signal for outputting illumination light having a uniform illumination intensity distribution and outputs the illumination control signal to the illumination unit 40.

The illumination unit 40 includes a light source 41, a spatial light modulation unit 42, a light guide 45, and an illumination optical system 46. The illumination unit 40 modulates illumination light emitted from the light source 41 in the spatial light modulation unit 42 based on the illumination control signal from the output controller 39 and irradiates the object with the illumination light whose illumination intensity is adjusted, via the light guide 45 and the illumination optical system 46.

The system controller 50 operates the imaging unit 22, the illumination controller 30, and the illumination unit 40 in synchronization with one another. Specifically, the system controller 50 switches the illumination mode in synchronization with a frame switching timing such that an image captured in illumination of the measurement light mode and an image captured in illumination of the correction light mode are not mixed in one frame. It should be noted that instead of the output controller 39, the system controller 50 may select the illumination mode of each frame from the measurement light mode and the correction light mode.

In this manner, the correction illumination calculation unit 38 calculates an illumination intensity distribution in consideration of the distance to the object. Therefore, it is possible to adjust the illumination light to have an optimal illumination intensity with respect to both an object at a close position and an object at a distant position. Further, the use of the stereo camera as the imaging unit 22 allows the display apparatus 91 to stereoscopically display the object. Furthermore, the use of the stereo camera allows the distance measurement unit 32 to be eliminated and the illumination intensity to be adjusted such that the blown-out highlights, blocked-up shadows, or the like are not generated in consideration of the distance to the object.

### 8. Modified Example 5

Modified Example 5 shows a case of performing a three-dimensional structure analysis on an object by a so-called light-section method and adjusting an illumination intensity based on an analysis result. It should be noted that in the light-section method, an object is irradiated with slit light to perform a three-dimensional structure analysis.

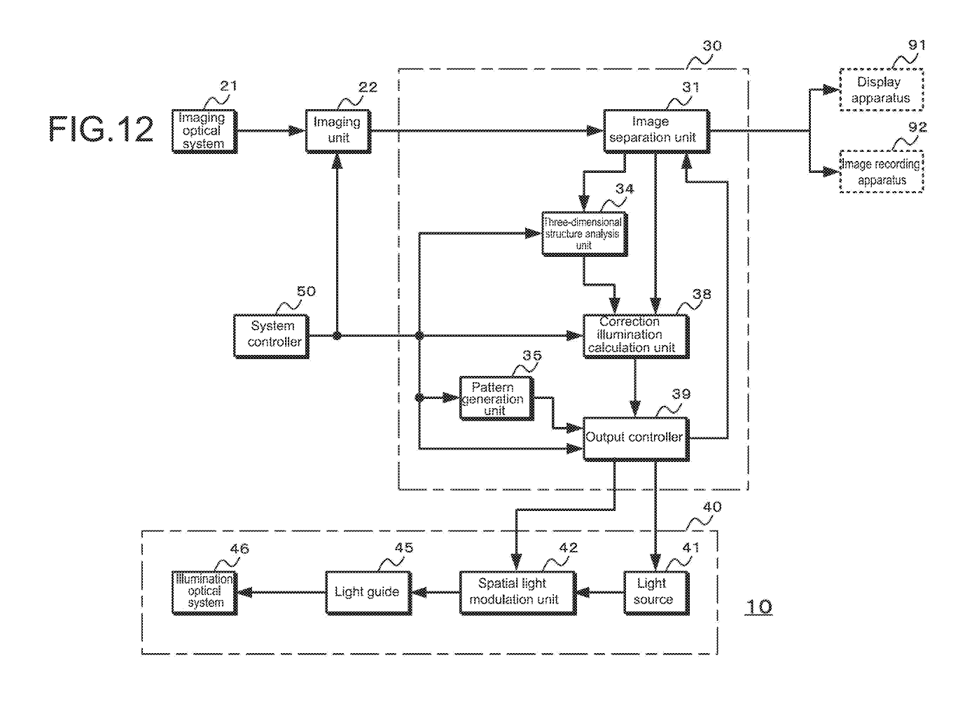

FIG. 12 shows a configuration of Modified Example 5. An imaging apparatus 10 of Modified Example 5 includes an imaging optical system 21, an imaging unit 22, an illumination controller 30, an illumination unit 40, and a system controller 50. Additionally, the illumination controller 30 includes an image separation unit 31, a three-dimensional structure analysis unit 34, a pattern generation unit 35, a correction illumination calculation unit 38, and an output controller 39.

The imaging optical system 21 is constituted of a lens unit for focusing on an object.

The imaging unit 22 is constituted of an imaging device such as a CCD (Charge Coupled Device) image sensor and a CMOS (Complementary Metal-Oxide Semiconductor) image sensor and generates an image signal corresponding to an optical image of the object. Further, the imaging unit 22 synchronizes with the illumination unit 40 based on a synchronizing signal supplied from the system controller 50 to perform an imaging operation. In addition, the imaging unit 22 performs various types of processing on the generated image signal.

The image separation unit 31 segments the image signal of the captured image in units of screens, for example, at a position of frame switching, based on an illumination mode signal from the output controller 39. In the case where the illumination mode signal indicates that illumination is set to a correction light mode, the image separation unit 31 outputs an image signal of an image captured in illumination of the correction light mode to a display apparatus 91 or an image recording apparatus 92, for example. Further, in the case where the illumination mode signal indicates that illumination is set to a measurement light mode, the image separation unit 31 outputs an image signal of an image captured in illumination of the measurement light mode to the correction illumination calculation unit 38. Furthermore, in the case where the illumination mode signal indicates that illumination is set to a three-dimensional measurement light mode, the image separation unit 31 outputs an image signal of an image captured in illumination of the three-dimensional measurement light mode to the three-dimensional structure analysis unit 34. In the three-dimensional measurement light mode, the illumination unit 40 performs irradiation and scanning (for example, horizontal movement) with slit light. In addition, the image separation unit 31 performs interpolation processing using the image signal of the image captured in illumination of the correction light mode in a period of time during which illumination is set to the measurement light mode. The image separation unit 31 performs the interpolation processing to generate an image signal of an image corresponding to the image captured in illumination of the correction light mode and then outputs the image signal to the display apparatus 91 or the image recording apparatus 92, for example.

The three-dimensional structure analysis unit 34 determines the shape of a portion irradiated with the slit light based on the image signal supplied from the image separation unit 31. Further, by the determination of the shape of a portion irradiated with the slit light at each scanning position of the slit light, the three-dimensional structure of the object is analyzed. The three-dimensional structure analysis unit 34 outputs an analysis result to the correction illumination calculation unit 38.

The pattern generation unit 35 generates a pattern signal as a three-dimensional measurement pattern, with which the irradiation and scanning (for example, horizontal movement) with the slit light from the illumination unit 40 are performed. Then, the pattern generation unit 35 outputs the pattern signal to the output controller 39.

The correction illumination calculation unit 38 calculates an illumination intensity distribution of illumination light in the correction light mode, based on the analysis result from the three-dimensional structure analysis unit 34 and the image signal of the image captured in illumination of the measurement light mode. In the measurement light mode, illumination light having a uniform illumination intensity distribution is output from the illumination unit 40. In an image captured in such illumination of the measurement light mode, an object part with a high reflectance or a close object part has high luminance, and an object part with a low reflectance or a distant object part has low luminance. Therefore, the correction illumination calculation unit 38 calculates an illumination intensity distribution of illumination light in the correction light mode such that a captured image in which blown-out highlights, blocked-up shadows, or the like are not generated can be obtained even if object parts with different reflectances and object parts having different distances are mixed in the imaged range. The correction illumination calculation unit 38 adjusts the illumination intensity in consideration of the distance to the object as in Modified Examples 3 and 4.

The output controller 39 switches the illumination mode to the measurement light mode, to the correction light mode, or to the three-dimensional measurement light mode based on a control signal from the system controller 50. Further, the output controller 39 generates an illumination mode signal indicating to which of the measurement light mode, the correction light mode, and the three-dimensional measurement light mode the illumination mode is set, and outputs the illumination mode signal to the image separation unit 31. Further, the output controller 39 generates an illumination control signal based on a calculation result of the illumination intensity distribution in the correction illumination calculation unit 38 and outputs the illumination control signal to the illumination unit 40. Thus, the output controller 39 controls the illumination intensity of the illumination light in the correction light mode. Further, in the measurement light mode, the output controller 39 generates an illumination control signal for outputting illumination light having a uniform illumination intensity distribution and outputs the illumination control signal to the illumination unit 40. Furthermore, in the three-dimensional measurement light mode, the output controller 39 generates an illumination control signal based on the pattern signal from the pattern generation unit 35 and outputs the illumination control signal to the illumination unit 40.

The illumination unit 40 includes a light source 41, a spatial light modulation unit 42, a light guide 45, and an illumination optical system 46. The illumination unit 40 modulates illumination light emitted from the light source 41 in the spatial light modulation unit 42 based on the illumination control signal from the output controller 39 and irradiates the object with the illumination light whose illumination intensity is adjusted, via the light guide 45 and the illumination optical system 46.

The system controller 50 operates the imaging unit 22, the illumination controller 30, and the illumination unit 40 in synchronization with one another. Specifically, the system controller 50 switches the illumination mode in synchronization with a frame switching timing such that an image captured in illumination of the measurement light mode, an image captured in illumination of the correction light mode, and an image captured in illumination of the three-dimensional measurement light mode are not mixed in one frame. It should be noted that instead of the output controller 39, the system controller 50 may select the illumination mode of each frame from the measurement light mode, the correction light mode, and the three-dimensional measurement light mode.

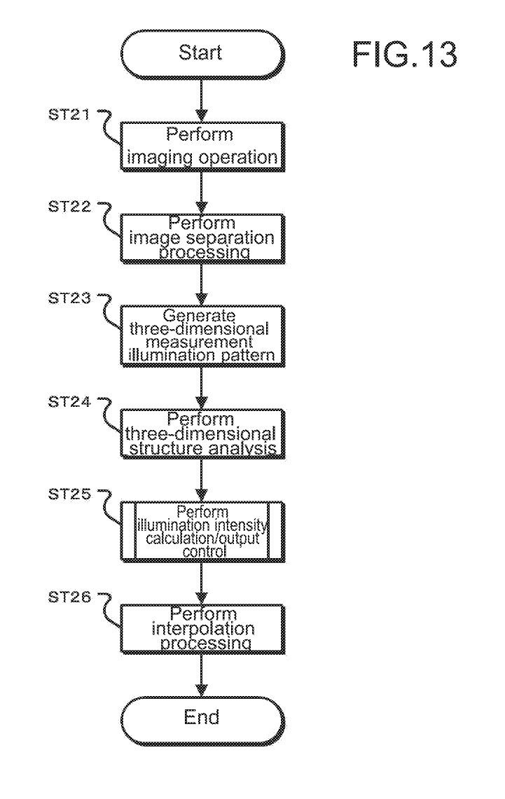

FIG. 13 is a flowchart showing operations of the imaging apparatus in Modified Example 5. In Step ST21, the imaging apparatus 10 performs an imaging operation. The imaging apparatus 10 captures an image of an object, generates a moving image, and proceeds to Step ST22.

In Step ST22, the imaging apparatus 10 performs image separation processing. The imaging apparatus 10 separates a frame of an image captured in illumination of the measurement light mode from a frame of an image captured in illumination of the correction light mode. Additionally, the imaging apparatus 10 separates a frame of an image captured in illumination of the three-dimensional correction light mode from the other frames and then proceeds to Step ST23.

In Step ST23, the imaging apparatus 10 generates a three-dimensional measurement illumination pattern. The imaging apparatus 10 generates a pattern signal for emitting slit light for scanning and then proceeds to Step ST24.

In Step ST24, the imaging apparatus 10 performs a three-dimensional structure analysis. The imaging apparatus 10 determines the shape of a portion irradiated with the slit light. Further, by the determination of the shape of a portion irradiated with the slit light at each scanning position of the slit light, the imaging apparatus 10 analyzes the three-dimensional structure of the object and proceeds to Step ST25.

In Step ST25, the imaging apparatus 10 performs illumination intensity calculation/output control. The imaging apparatus 10 performs processing of the flowchart shown in FIG. 4. The imaging apparatus 10 calculates an illumination intensity distribution, performs illumination light output control to obtain the calculated illumination intensity distribution, and proceeds to Step ST26.

In Step ST26, the imaging apparatus 10 performs interpolation processing using an image signal of the image captured in illumination of the correction light mode. The imaging apparatus 10 generates an image signal of an image corresponding to the image captured in illumination of the correction light mode by the interpolation processing, with respect to a period of time during which the illumination is provided in the measurement light mode and the three-dimensional measurement light mode. Further, the imaging apparatus 10 outputs the image signal of the image captured in illumination of the correction light mode and the image signal of the captured image that is generated by the interpolation processing in a period of time during which the measurement light mode and the three-dimensional measurement light mode are set, to the display apparatus 91, the image recording apparatus 92, or the like.

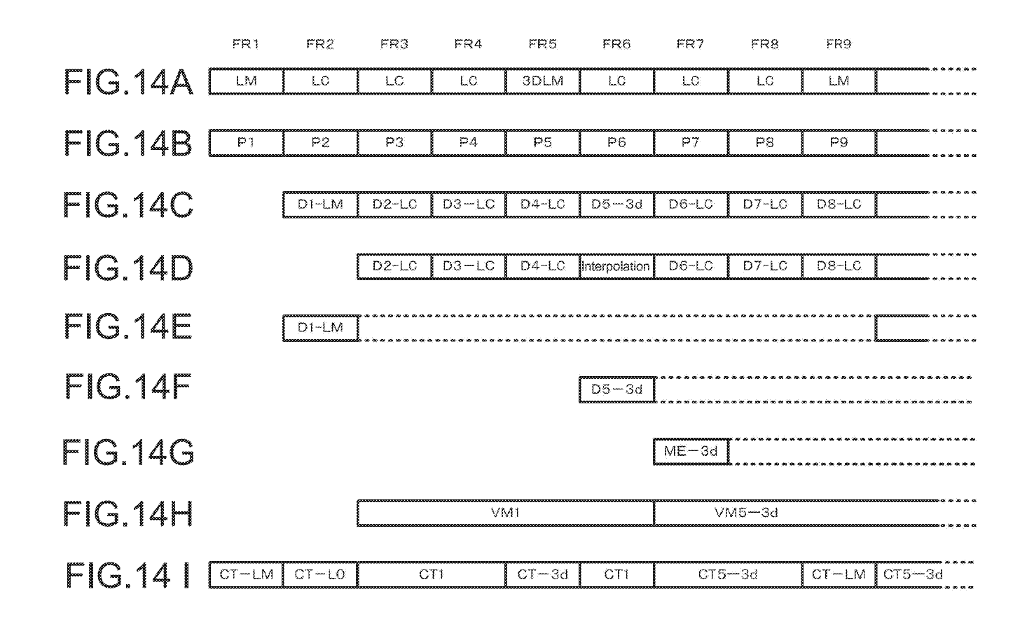

FIGS. 14A to 14I are timing charts each showing an operation of the imaging apparatus in Modified Example 5. FIG. 14A shows the illumination mode. FIG. 14B shows frames in an imaging operation. FIG. 14C shows frames of image signals supplied to the image separation unit 31. FIG. 14D shows frames of image signals output from the image separation unit 31. FIG. 14E shows frames of image signals supplied to the correction illumination calculation unit 38. FIG. 14F shows frames of image signals supplied to the three-dimensional structure analysis unit 34. FIG. 14G shows analysis results of the three-dimensional structure. FIG. 14H shows calculation results of an illumination intensity distribution. FIG. 14I shows illumination control signals.

Based on the illumination control signal from the output controller 39, for example, the illumination unit 40 provides illumination in the measurement light mode in only one frame period and then provides illumination in the correction light mode in the following three frame periods. Further, when the illumination in the correction light mode is finished, illumination in the three-dimensional measurement light mode is provided in only one frame period. When the illumination in the three-dimensional correction light mode is finished, illumination in the measurement light mode is provided again in only one frame period. After that, the illumination mode is switched in the same manner.

In the case where the imaging apparatus 10 sets the illumination mode to the measurement light mode (LM) in the first frame FR1 as shown in 14A, for example, the imaging apparatus 10 outputs a signal “CT-LM” serving as an illumination control signal from the output controller 39 to the illumination unit 40 as shown in FIG. 14I. It should be noted that the signal “CT-LM” is a signal for outputting the illumination light in the measurement light mode from the illumination unit 40. Further, the imaging unit 22 performs an imaging operation P1 on an object illuminated in the measurement light mode.

In the case where the imaging apparatus 10 sets the illumination mode to the correction light mode (LC) in the second frame FR2 as shown in FIG. 14A, the imaging apparatus 10 outputs a signal “CT-L0” serving as an illumination control signal from the output controller 39 to the illumination unit 40 as shown in FIG. 14I. In this case, the illumination intensity distribution of the illumination light in the correction light mode is not completely calculated, and therefore the output controller 39 outputs the signal “CT-L0” in which the illumination intensity is an initial value. The imaging unit 22 performs an imaging operation P2 on the object illuminated in the correction light mode. Further, the imaging unit 22 supplies an image signal “D1-LM”, which is generated in the imaging operation P1, to the image separation unit 31 as shown in FIG. 14C. Here, the image signal supplied from the imaging unit 22 is the image signal obtained when the object illuminated in the measurement light mode is imaged. Therefore, the image separation unit 31 supplies the image signal “D1-LM” to the correction illumination calculation unit 38 as shown in FIG. 14E to calculate an illumination intensity distribution based on the image signal “D1-LM”.

In the case where the imaging apparatus 10 sets the illumination mode to the correction light mode (LC) in the third frame FR3 as shown in FIG. 14A, the imaging apparatus 10 outputs a signal “CT1” serving as an illumination control signal from the output controller 39 to the illumination unit 40 as shown in FIG. 14I. Here, it is assumed that the correction illumination calculation unit 38 calculates an illumination intensity distribution in the correction light mode based on the image signal “D1-LM” and obtains a calculation result “VM1” as shown in FIG. 14H. In this case, the output controller 39 generates the signal “CT1” based on the calculation result “VM1” and outputs the signal “CT1” to the illumination unit 40. Therefore, the imaging unit 22 can obtain an excellent captured image in which blown-out highlights, blocked-up shadows, or the like are not generated, when performing an imaging operation P3 on the object illuminated in the correction light mode. Further, as shown in FIG. 14C, the imaging unit 22 outputs an image signal “D2-LC”, which is generated in the imaging operation P2, to the image separation unit 31. Since the image signal supplied from the imaging unit 22 is the image signal obtained when the object illuminated in the correction light mode is imaged, the image separation unit 31 outputs the image signal “D2-LC” to the display apparatus 91 or the image recording apparatus 92.

After that, in the case where the imaging apparatus 10 sets the illumination mode to the three-dimensional measurement light mode (3DLM) in the fifth frame FR5 as shown in FIG. 14A, the imaging apparatus 10 outputs a signal “CT-3d” serving as an illumination control signal from the output controller 39 to the illumination unit 40 as shown in FIG. 14I. Further, the imaging unit 22 performs an imaging operation P5 on the object illuminated in the three-dimensional measurement light mode. It should be noted that the signal “CT-3d” is a signal for outputting the illumination light in the three-dimensional measurement light mode from the illumination unit 40.

In the case where the imaging apparatus 10 sets the illumination mode to the correction light mode (LC) in the sixth frame FR6 as shown in FIG. 14A, the imaging apparatus 10 outputs a signal “CT1” serving as an illumination control signal from the output controller 39 to the illumination unit 40 as shown in FIG. 14I. Further, in the frame FR6, the imaging unit 22 outputs an image signal “D5-3d”, which is generated in the imaging operation P5 as shown in FIG. 14C, to the image separation unit 31. The image signal supplied from the imaging unit 22 is the image signal obtained when the object illuminated in the three-dimensional measurement light mode is imaged. Therefore, the image separation unit 31 supplies the image signal “D5-3d” to the three-dimensional structure analysis unit 34 as shown in FIG. 14F and analyzes a three-dimensional structure. Further, in the case where the image signal supplied to the image separation unit 31 is the image signal obtained when the object illuminated in the measurement light mode or the three-dimensional measurement light mode is imaged, the image signal to be output to the display apparatus 91 or the image recording apparatus 92 is absent. Therefore, the image separation unit 31 performs interpolation processing using the image signal obtained when the object illuminated in the measurement light mode is imaged, and outputs the generated image signal to the display apparatus 91 or the image recording apparatus 92 during the period of the frame FR6. In the interpolation processing, the first to third interpolation processing methods described above or other interpolation processing methods are used.

In the case where the imaging apparatus 10 sets the illumination mode to the correction light mode (LC) in the seventh frame FR7 as shown in FIG. 14A, the imaging apparatus 10 outputs a signal “CT5-3d” serving as an illumination control signal from the output controller 39 to the illumination unit 40 as shown in FIG. 14I. Here, it is assumed that the three-dimensional structure analysis unit 34 obtains an analysis result “ME-3d” as shown in FIG. 14G. Further, it is assumed that the correction illumination calculation unit 38 calculates an illumination intensity distribution based on the analysis result “ME-3d” and then obtains a calculation result “VM5-3d” as shown in FIG. 14F. In this case, the output controller 39 generates the signal “CT5-3d” based on the calculation result “VM5-3d” and outputs the signal “CT5-3d” to the illumination unit 40. When the imaging unit 22 performs an imaging operation P7 on the object illuminated in the correction light mode, illumination is provided in the illumination intensity distribution in which the three-dimensional structure is considered. Therefore, the imaging unit 22 can obtain an excellent captured image in which blown-out highlights, blocked-up shadows, or the like are not generated. Further, the imaging unit 22 outputs an image signal “D6-LC”, which is generated in the imaging operation P6 as shown in FIG. 14C, to the image separation unit 31.

Since the image signal supplied from the imaging unit 22 is the image signal obtained when the object illuminated in the correction light mode is imaged, the image separation unit 31 outputs the image signal “D6-LC” to the display apparatus 91 or the image recording apparatus 92.

In the case where the imaging apparatus 10 sets the illumination mode to the correction light mode (LC) in the eighth frame FR8 as shown in FIG. 14A, the imaging apparatus 10 outputs a signal “CT5-3d” serving as an illumination control signal from the output controller 39 to the illumination unit 40 as shown in FIG. 14I. When the imaging unit 22 performs an imaging operation P8 on the object illuminated in the correction light mode, illumination is provided in the illumination intensity distribution in which the three-dimensional structure is considered. Therefore, the imaging unit 22 can obtain an excellent captured image in which blown-out highlights, blocked-up shadows, or the like are not generated. Further, the imaging unit 22 outputs an image signal “D7-LC”, which is generated in the imaging operation P7 as shown in FIG. 14C, to the image separation unit 31. Since the image signal supplied from the imaging unit 22 is the image signal obtained when the object illuminated in the correction light mode is imaged, the image separation unit 31 outputs the image signal “D7-LC” to the display apparatus 91 or the image recording apparatus 92.

As described above, the imaging apparatus 10 analyzes the three-dimensional structure of an object based on an image captured in illumination of the three-dimensional measurement light mode. Further, the imaging apparatus 10 adjusts the illumination intensity such that the illumination intensity of a close object part is reduced and the illumination intensity of a distant object part is increased in the correction light mode. Therefore, the imaging apparatus 10 can set the illumination intensity distribution in the measurement light mode so as to correspond to the three-dimensional structure of the object. As a result, the image captured in illumination of the measurement light mode can be provided as an excellent captured image in which blown-out highlights, blocked-up shadows, or the like are not generated. In addition, the imaging apparatus 10 periodically performs the imaging operation in the three-dimensional measurement light mode and calculates an illumination intensity distribution in the correction light mode based on the image signal generated by the imaging operation in the three-dimensional measurement light mode. Therefore, even in the case where the object moves or the status of the object changes during the imaging, the illumination intensity distribution in the correction light mode is automatically adjusted following the change of the three-dimensional structure of the object. Therefore, the imaging apparatus 10 can easily obtain an excellent captured image in which blown-out highlights, blocked-up shadows, or the like are not generated, irrespective of the change of the object. Furthermore, the imaging apparatus 10 can prevent the object from generating heat due to the illumination light, for example.

### 9. Modified Example 6

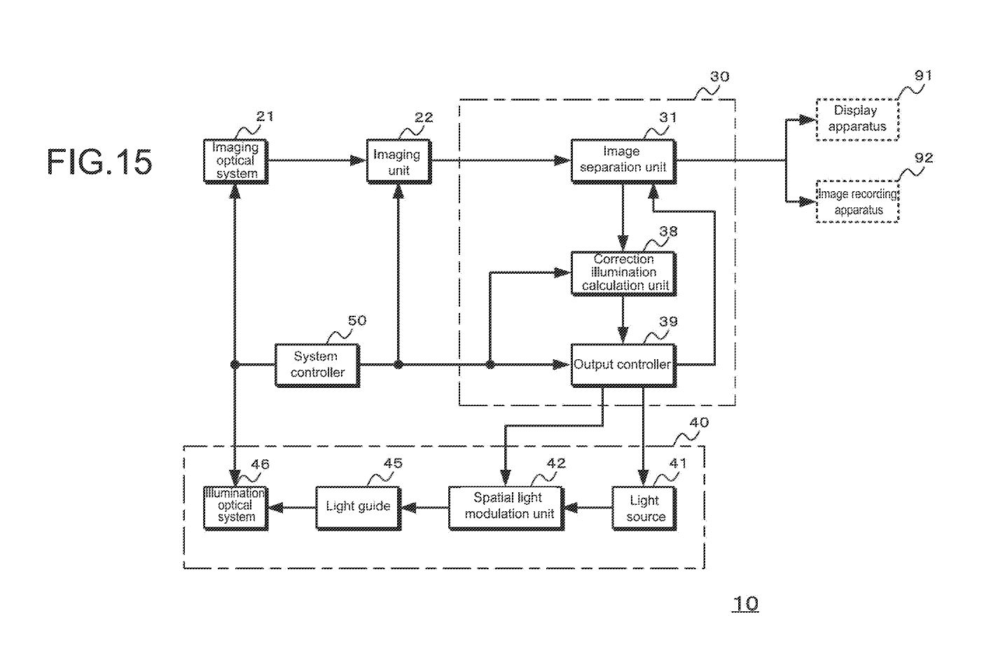

Modified Example 6 shows a case in which the imaging optical system 21 and the illumination optical system 46 are each provided with a zoom function. FIG. 15 shows a configuration of Modified Example 6. An imaging apparatus 10 of Modified Example 6 includes an imaging optical system 21, an imaging unit 22, an illumination controller 30, an illumination unit 40, and a system controller 50. Additionally, the illumination controller 30 includes an image separation unit 31, a correction illumination calculation unit 38, and an output controller 39.

The imaging optical system 21 is constituted of a lens unit for focusing on an object. A zoom lens is used in the imaging optical system 21 of Modified Example 6. The zoom lens is driven based on a zoom control signal from the system controller 50 to be described later, thus performing a zoom operation.

The imaging unit 22 is constituted of an imaging device such as a CCD (Charge Coupled Device) image sensor and a CMOS (Complementary Metal-Oxide Semiconductor) image sensor and generates an image signal corresponding to an optical image of the object. Further, the imaging unit 22 synchronizes with the illumination unit 40 based on a synchronizing signal supplied from the system controller 50 to perform an imaging operation. In addition, the imaging unit 22 performs various types of processing on the generated image signal.

The image separation unit 31 segments the image signal of the captured image in units of screens, for example, at a position of frame switching, based on an illumination mode signal from the output controller 39. In the case where the illumination mode signal indicates that illumination is set to a correction light mode, the image separation unit 31 outputs an image signal of an image captured in illumination of the correction light mode to a display apparatus 91 or an image recording apparatus 92, for example. Further, in the case where the illumination mode signal indicates that illumination is set to a measurement light mode, the image separation unit 31 outputs an image signal of an image captured in illumination of the measurement light mode to the correction illumination calculation unit 38. In addition, the image separation unit 31 performs interpolation processing using the image signal of the image captured in illumination of the correction light mode in a period of time during which illumination is set to the measurement light mode. The image separation unit 31 performs the interpolation processing to generate an image signal of an image corresponding to the image captured in illumination of the correction light mode and then outputs the image signal to the display apparatus 91 or the image recording apparatus 92, for example.

The correction illumination calculation unit 38 calculates an illumination intensity distribution of illumination light in the correction light mode, based on the image signal of the image captured in illumination of the measurement light mode. In the measurement light mode, illumination light having a uniform illumination intensity distribution is output from the illumination unit 40. In an image captured in such illumination of the measurement light mode, an object part with a high reflectance or a close object part has high luminance, and an object part with a low reflectance or a distant object part has low luminance. Therefore, the correction illumination calculation unit 38 calculates an illumination intensity distribution of illumination light in the correction light mode such that a captured image in which blown-out highlights, blocked-up shadows, or the like are not generated can be obtained even if object parts with different reflectances and object parts having different distances are mixed in the imaged range.

The output controller 39 switches the illumination mode to the measurement light mode or to the correction light mode based on a control signal from the system controller 50. Further, the output controller 39 generates an illumination mode signal indicating to which of the measurement light mode and the correction light mode the illumination mode is set, and outputs the illumination mode signal to the image separation unit 31. Further, the output controller 39 generates an illumination control signal based on a calculation result of the illumination intensity distribution in the correction illumination calculation unit 38 and outputs the illumination control signal to the illumination unit 40. Thus, the output controller 39 controls the illumination intensity of the illumination light in the correction light mode. Further, in the measurement light mode, the output controller 39 generates an illumination control signal for outputting illumination light having a uniform illumination intensity distribution and outputs the illumination control signal to the illumination unit 40.

The illumination unit 40 includes a light source 41, a spatial light modulation unit 42, a light guide 45, and an illumination optical system 46. The illumination unit 40 modulates illumination light emitted from the light source 41 in the spatial light modulation unit 42 based on the illumination control signal from the output controller 39 and irradiates the object with the illumination light whose illumination intensity is adjusted, via the light guide 45 and the illumination optical system 46. Further, the illumination optical system 46 is provided with a zoom function and performs a zoom operation of the illumination light based on the zoom control signal from the system controller 50.

The system controller 50 operates the imaging unit 22, the illumination controller 30, and the illumination unit 40 in synchronization with one another. Specifically, the system controller 50 switches the illumination mode in synchronization with a frame switching timing such that an image captured in illumination of the measurement light mode and an image captured in illumination of the correction light mode are not mixed in one frame. It should be noted that instead of the output controller 39, the system controller 50 may select the illumination mode of each frame from the measurement light mode and the correction light mode. Further, the system controller 50 generates a zoom control signal in accordance with an operation of a user or the like and outputs the zoom control signal to the imaging optical system 21 and the illumination optical system 46. Thus, the imaging optical system 21 and the illumination optical system 46 operate in synchronization with each other.

In such a manner, the zoom operation of the imaging optical system 21 and the zoom operation of the illumination optical system 46 are performed in synchronization with each other. Therefore, even if the zoom operation is performed in the imaging optical system 21, the operation of the illumination unit 40 can be simultaneously performed such that blown-out highlights or blocked-up shadows are not generated.

### 10. Modified Example 7

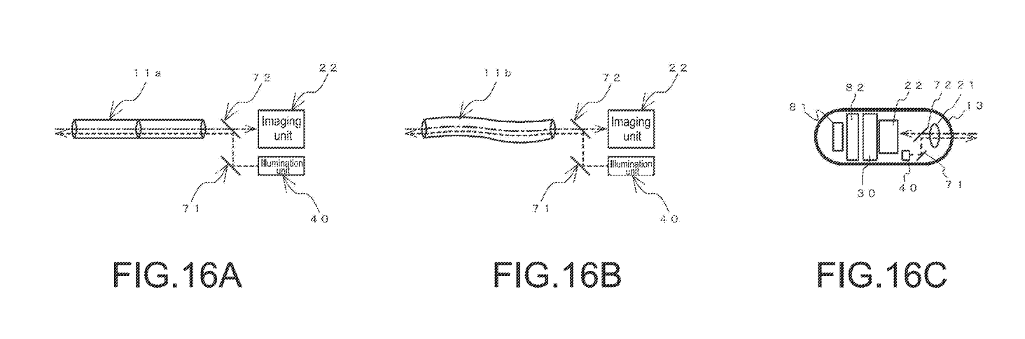

Modified Example 7 is a modified example on an optical path of illumination light as shown in FIGS. 16A to 16C. FIG. 16A shows a rigid endoscope apparatus, FIG. 16B shows a flexible endoscope apparatus, and FIG. 16C shows a capsule endoscope apparatus.

In the case of the rigid endoscope apparatus, illumination light emitted from an illumination unit 40 enters a beam splitter 72 by a mirror 71. The beam splitter 72 transmits the illumination light emitted from the illumination unit 40 to an object via a relay lens within an image guide shaft of an insertion unit 11a or an imaging optical system. Further, the beam splitter 72 transmits light supplied from an observation target to the imaging unit 22 via the imaging optical system and the relay lens within the image guide shaft of the insertion unit 11a.

In the same manner as in the rigid endoscope apparatus, in the flexible endoscope apparatus, illumination light emitted from an illumination unit 40 enters a beam splitter 72 by a mirror 71. The beam splitter 72 transmits the illumination light emitted from the illumination unit 40 to a light guide of a flexible insertion unit 11b. Further, the beam splitter 72 transmits light supplied from an observation target to the imaging unit 22 via the imaging optical system and the light guide.

The capsule endoscope apparatus includes an imaging optical system 21, an imaging unit 22, an illumination controller 30, and an illumination unit 40, for example, in a casing 13. Further, the capsule endoscope apparatus includes a wireless communication unit 81, a power source unit 82, and the like. The wireless communication unit 81 is used for transmitting a processed image signal, for example. The illumination light emitted from the illumination unit 40 enters a beam splitter 72 by a mirror 71. The beam splitter 72 transmits the illumination light emitted from the illumination unit 40 to an object via the imaging optical system 21. Further, the beam splitter 72 transmits light supplied from an observation target to the imaging unit 22 via the imaging optical system 21.

In such a manner, the mirror 71 and the beam splitter 72 are used as an optical path controller, and the optical path that guides light from an object to the imaging unit 22 is also used as an optical path of illumination light. As a result, the configuration of the insertion unit or the capsule endoscope apparatus can be made simpler than the case where the optical path of the illumination light is provided separately.

Up to here, the present disclosure has been described using the embodiment and some modified examples. However, the present disclosure is not limited to the embodiment and some modified examples and may be achieved by combining the embodiment and modified examples described above. In addition, the series of processing described in the specification can be executed by hardware, software, or a combined configuration of hardware and software. In the case where processing is executed by software, a program in which a processing sequence is recorded is installed in a memory in a computer built in special hardware and then executed. Alternatively, the program may be installed in a general-purpose computer capable of executing various types processing and then executed.

For example, a program may be recorded in advance in a hard disk or a ROM (Read Only Memory) serving as a recording medium. Alternatively, a program can be stored (recorded) temporarily or permanently in removable recording media such as a flexible disc, a CD-ROM (Compact Disc Read Only Memory), an MO (Magneto optical) disc, a DVD (Digital Versatile Disc), a magnetic disc, and a semiconductor memory card. Such removable recording media can be provided as so-called package software.

In addition, a program may be installed in a computer from a removable recording medium as well as transferred from a download site to a computer in a wireless or wired manner via a network such as a LAN (Local Area Network) or the Internet. The computer receives a program transmitted in such a manner and installs the program in a built-in recording medium such as a hard disk.

The present disclosure should not be construed to be limited to the embodiment described above. The embodiment discloses the present disclosure in the form of examples, and it is apparent that persons skilled in the art can modify or substitute the embodiment without departing from the gist of the present disclosure. In other words, in order to determine the gist of the present disclosure, the section “What is claimed is” should be taken into consideration.

It should be noted that the image processing apparatus according to the embodiment of the present disclosure can take the following configurations.

(1) An image processing apparatus, including:

an image separation unit configured to separate, from a captured image, an image captured in illumination of a measurement light mode in which an illumination intensity distribution is set to a predetermined spatial distribution;

a correction illumination calculation unit configured to calculate an illumination intensity distribution in a correction light mode in which illumination corresponding to an object is provided, based on the image separated in the image separation unit; and

an output controller configured to perform output control of illumination light based on the illumination intensity distribution calculated in the correction illumination calculation unit.

(2) The image processing apparatus according to (1), in which

the predetermined spatial distribution in the measurement light mode includes a spatial distribution of a uniform illumination intensity.

(3) The image processing apparatus according to (1) or (2), in which

the correction illumination calculation unit is configured to perform resolution conversion processing on the image in accordance with a spatial resolution of the illumination light and to calculate an illumination intensity distribution based on an image obtained after the resolution conversion processing.

(4) The image processing apparatus according to any one of (1) to (3), in which

the correction illumination calculation unit is configured to perform color separation processing on the image separated in the image separation unit and to calculate an illumination intensity distribution in the correction light mode based on an image of each color component.

(5) The image processing apparatus according to any one of (1) to (4), in which

the image separation unit is configured to perform interpolation using an image captured in illumination of the correction light mode and to generate an image that is captured in illumination of the correction light mode and corresponds to a period of the image captured in illumination of the measurement light mode.

(6) The image processing apparatus according to any one of (1) to (5), further including:

an imaging unit configured to generate the captured image; and

an operation controller configured to operate the image separation unit, the correction illumination calculation unit, and the output controller in synchronization with one another.

(7) The image processing apparatus according to any one of (1) to (6), further including an optical path controller configured to use an optical path guiding light from the object to the imaging unit as an optical path of the illumination light.
(8) The image processing apparatus according to any one of (1) to (7), further including an illumination unit configured to output the illumination light, to perform spatial light modulation of the illumination light output from a light source based on a control signal from the output controller, and to set an illumination intensity distribution of the illumination light output in the correction light mode to be a distribution calculated in the correction illumination calculation unit.
(9) The image processing apparatus according to any one of (1) to (7), further including an illumination unit configured to output the illumination light, to drive a light-emitting device based on a control signal from the output controller, and to set an illumination intensity distribution of the illumination light output in the correction light mode to be a distribution calculated in the correction illumination calculation unit.
(10) The image processing apparatus according to any one of (1) to (9), further including a distance measurement unit configured to measure a distance from each of points on the captured image to the object, in which

the correction illumination calculation unit is configured to calculate the illumination intensity distribution in the correction light mode based on one of the distance measured in the distance measurement unit and both the measured distance and the image separated in the image separation unit.

(11) The image processing apparatus according to any one of (1) to (9), further including:

an imaging unit configured to generate a multi-view captured image as the captured image; and

a distance estimation unit configured to estimate a distance from each of points on the captured image to the object by using the multi-view captured image, in which

the correction illumination calculation unit is configured to calculate the illumination intensity distribution in the correction light mode based on one of the distance estimated in the distance estimation unit and both the estimated distance and the image separated in the image separation unit.

(12) The image processing apparatus according to any one of (1) to (9), further including:

a pattern generation unit configured to generate an illumination light pattern in a three-dimensional measurement light mode in which a three-dimensional structure analysis of the object is performed; and

a three-dimensional structure analysis unit configured to perform a three-dimensional structure analysis of the object based on an image captured in illumination of the three-dimensional measurement light mode, in which

the image separation unit is configured to separate the image captured in illumination of the three-dimensional measurement light mode and output the image to the three-dimensional structure analysis unit, and

the correction illumination calculation unit is configured to calculate the illumination intensity distribution in the correction light mode based on an analysis result of the three-dimensional structure analysis unit.

(13) The image processing apparatus according to any one of (1) to (12), further including:

an imaging optical system used to generate the captured image; and

an illumination optical system used to emit the illumination light, in which

the imaging optical system and the illumination optical system perform a zoom operation in synchronization with each other.

In the image processing apparatus and the image processing method according to the embodiment of the present disclosure, an image captured in illumination of a measurement light mode in which an illumination intensity distribution is set to a predetermined spatial distribution is separated from a captured image. Based on the separated image, an illumination intensity distribution in a correction light mode in which illumination corresponding to an object is provided is calculated, and output control of illumination light in the correction light mode is performed based on the calculated illumination intensity distribution. Therefore, the image captured in illumination of the correction light mode is provided as an image captured in illumination in which light distribution control with a high spatial resolution corresponding to an object is performed. As a result, a captured image in which blown-out highlights, blocked-up shadows, or the like are not generated can be generated, for example. Therefore, the image processing apparatus and the image processing method according to the embodiment of the present disclosure are suitable for an endoscope apparatus, a fiberscope, and the like.

The present disclosure contains subject matter related to that disclosed in Japanese Priority Patent Application JP 2012-094660 filed in the Japan Patent Office on Apr. 18, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus, comprising:
an image separation unit configured to separate, from a captured image, an image captured in illumination of a measurement light mode in which an illumination intensity distribution is set to a predetermined spatial distribution;
a correction illumination calculation unit configured to calculate an illumination intensity distribution in a correction light mode in which illumination corresponding to an object is provided, based on the image separated in the image separation unit; and
an output controller configured to perform output control of illumination light based on the illumination intensity distribution calculated in the correction illumination calculation unit.

2. The image processing apparatus according to claim 1, wherein
the predetermined spatial distribution in the measurement light mode includes a spatial distribution of a uniform illumination intensity.

3. The image processing apparatus according to claim 1, wherein
the correction illumination calculation unit is configured to perform resolution conversion processing on the image in accordance with a spatial resolution of the illumination light and to calculate an illumination intensity distribution based on an image obtained after the resolution conversion processing.

4. The image processing apparatus according to claim 1, wherein
the correction illumination calculation unit is configured to perform color separation processing on the image separated in the image separation unit and to calculate an illumination intensity distribution in the correction light mode based on an image of each color component.

5. The image processing apparatus according to claim 1, wherein
the image separation unit is configured to perform interpolation using an image captured in illumination of the correction light mode and to generate an image that is captured in illumination of the correction light mode and corresponds to a period of the image captured in illumination of the measurement light mode.

6. The image processing apparatus according to claim 1, further comprising:
an imaging unit configured to generate the captured image; and
an operation controller configured to operate the image separation unit, the correction illumination calculation unit, and the output controller in synchronization with one another.

7. The image processing apparatus according to claim 6, further comprising an optical path controller configured to use an optical path guiding light from the object to the imaging unit as an optical path of the illumination light.

8. The image processing apparatus according to claim 1, further comprising an illumination unit configured to output the illumination light, to perform spatial light modulation of the illumination light output from a light source based on a control signal from the output controller, and to set an illumination intensity distribution of the illumination light output in the correction light mode to be a distribution calculated in the correction illumination calculation unit.

9. The image processing apparatus according to claim 1, further comprising an illumination unit configured to output the illumination light, to drive a light-emitting device based on a control signal from the output controller, and to set an illumination intensity distribution of the illumination light output in the correction light mode to be a distribution calculated in the correction illumination calculation unit.

10. The image processing apparatus according to claim 1, further comprising a distance measurement unit configured to measure a distance from each of points on the captured image to the object, wherein
the correction illumination calculation unit is configured to calculate the illumination intensity distribution in the correction light mode based on one of the distance measured in the distance measurement unit and both the measured distance and the image separated in the image separation unit.

11. The image processing apparatus according to claim 1, further comprising:
an imaging unit configured to generate a multi-view captured image as the captured image; and
a distance estimation unit configured to estimate a distance from each of points on the captured image to the object by using the multi-view captured image, wherein
the correction illumination calculation unit is configured to calculate the illumination intensity distribution in the correction light mode based on one of the distance estimated in the distance estimation unit and both the estimated distance and the image separated in the image separation unit.

12. The image processing apparatus according to claim 1, further comprising:
a pattern generation unit configured to generate an illumination light pattern in a three-dimensional measurement light mode in which a three-dimensional structure analysis of the object is performed; and
a three-dimensional structure analysis unit configured to perform a three-dimensional structure analysis of the object based on an image captured in illumination of the three-dimensional measurement light mode, wherein
the image separation unit is configured to separate the image captured in illumination of the three-dimensional measurement light mode and output the image to the three-dimensional structure analysis unit, and
the correction illumination calculation unit is configured to calculate the illumination intensity distribution in the correction light mode based on an analysis result of the three-dimensional structure analysis unit.

13. The image processing apparatus according to claim 1, further comprising:
an imaging optical system used to generate the captured image; and
an illumination optical system used to emit the illumination light, wherein
the imaging optical system and the illumination optical system perform a zoom operation in synchronization with each other.

14. An image processing method, comprising:
separating, from a captured image, an image captured in illumination of a measurement light mode in which an illumination intensity distribution is set to a predetermined spatial distribution;
calculating an illumination intensity distribution in a correction light mode in which illumination corresponding to an object is provided, based on the separated image; and
performing output control of illumination light based on the calculated illumination intensity distribution.
